(19) United States
(12) Patent Application Publication
(10) Pub. No.: US 2026/0362526 A1
(43) Pub. Date: Nov. 12, 2026

(54) EARLY INDICATION OF UPDATES TO WIRELESS PARAMETERS

(71) Applicant: QUALCOMM Incorporated, San Diego, CA (US)

(72) Inventors: Abhishek Pramod PATIL, San Diego, CA (US); Gaurang NAIK, San Diego, CA (US); George CHERIAN, San Diego, CA (US); Alfred ASTERJADHI, San Diego, CA (US); Sai Yiu Duncan HO, San Diego, CA (US); Sherief HELWA, San Diego, CA (US); Giovanni CHISCI, San Diego, CA (US); Sanket Sanjay KALAMKAR, San Diego, CA (US)

(21) Appl. No.: 19/673,670

(22) Filed: May 11, 2026

Related U.S. Application Data
(60) Provisional application No. 63/804,520, filed on May 12, 2025.

(51) Int. Cl. H04W 76/15; H04W 8/22; H04W 24/02

(52) U.S. Cl. CPC H04W 76/15; H04W 8/22; H04W 24/02

(57) ABSTRACT

This disclosure provides methods, components, devices and systems for early indication of updates to wireless parameters. Some aspects more specifically relate to indicating a critical update via an early portion of the management frame. In some examples, a wireless communication device may receive a management frame including one or more first fields and one or more second fields in an early portion of the management frame. The one or more first fields may include first information and the one or more second fields may include second information. The first information may relate to whether there is an update to one or more parameters associated with one or more basic service set identifiers (BSSIDs). The second information may indicate update information associated with the update to the one more parameters The wireless communication device and an AP may communicate in accordance with the first information and the second information.

### CROSS REFERENCE TO RELATED APPLICATION

The present Application for Patent claims benefit of U.S. Provisional Patent Application No. 63/804,520 by Patil et al., entitled “EARLY INDICATION OF UPDATES TO WIRELESS PARAMETERS,” filed May 12, 2025, which is assigned to the assignee hereof, and which is expressly incorporated by reference herein in its entirety.

### TECHNICAL FIELD

This disclosure relates generally to wireless communication and, more specifically, to early indication of updates to wireless parameters.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

An access point (AP) device may transmit a management frame (such as a beacon frame) to a wireless communication device (such as a station (STA)). The management frame may include control information for one or more basic service sets (BSSs) related to one or more identifiers (BSSIDs) served by an AP device. The AP device may serve one or more virtual APs each corresponding to a BSSID. The management frame may include an indication of an update, such as a critical update, for one or more types of wireless communication (such as one or more generations of wireless communication networks). The update may indicate that one or more parameters for a communication configuration at the AP have been updated. But if the wireless communication device does not receive the management frame including the indication of the update, the wireless communication device may perform a probe request to retrieve updates that may have occurred at the AP, and/or the wireless communication device may monitor for a complete management frame. Additionally, or alternatively, the wireless communication device may communicate with the AP in accordance with an outdated set of parameters.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communication by a wireless communication device. The method may include establishing a communication link with an access point (AP) of one or more APs, receiving, from the AP, a management frame including: one or more first fields and one or more second fields of a set of multiple fields in an early portion of the management frame, the one or more first fields being earlier in the management frame than the one or more second fields, the one or more first fields including first information related to whether there is an update to one or more parameters associated with one or more basic service set identifiers (BSSID) associated with the one or more APs, the one or more second fields including second information indicating update information associated with the update to the one or more parameters associated with the one or more BSSIDs associated with the one or more APs, the second information being in accordance with the first information indicating the update, and communicating, with the AP, in accordance with the first information and the second information.

Another innovative aspect of the subject matter described in this disclosure can be implemented in a wireless communication device. The wireless communication device may include a processing system that includes processor circuitry and memory circuitry that stores code. The processing system may be configured to cause the wireless communication device to establish a communication link with an AP of one or more APs, receive, from the AP, a management frame including: one or more first fields and one or more second fields of a set of multiple fields in an early portion of the management frame, the one or more first fields being earlier in the management frame than the one or more second fields, the one or more first fields including first information related to whether there is an update to one or more parameters associated with one or more BSSIDs associated with the one or more APs, the one or more second fields including second information indicating update information associated with the update to the one or more parameters associated with the one or more BSSIDs associated with the one or more APs, the second information being in accordance with the first information indicating the update, and communicate, with the AP, in accordance with the first information and the second information.

Another innovative aspect of the subject matter described in this disclosure can be implemented in a wireless communication device. The wireless communication device may include means for establishing a communication link with an AP of one or more APs, means for receiving, from the AP, a management frame including: one or more first fields and one or more second fields of a set of multiple fields in an early portion of the management frame, the one or more first fields being earlier in the management frame than the one or more second fields, the one or more first fields including first information related to whether there is an update to one or more parameters associated with one or more BSSIDs associated with the one or more APs, the one or more second fields including second information indicating update information associated with the update to the one or more parameters associated with the one or more BSSIDs associated with the one or more APs, the second information being in accordance with the first information indicating the update, and means for communicating, with the AP, in accordance with the first information and the second information.

Another innovative aspect of the subject matter described in this disclosure can be implemented in a non-transitory computer-readable medium storing code. The code may include instructions executable by one or more processors to establish a communication link with an AP of one or more APs, receive, from the AP, a management frame including: one or more first fields and one or more second fields of a set of multiple fields in an early portion of the management frame, the one or more first fields being earlier in the management frame than the one or more second fields, the one or more first fields including first information related to whether there is an update to one or more parameters associated with one or more BSSIDs associated with the one or more APs, the one or more second fields including second information indicating update information associated with the update to the one or more parameters associated with the one or more BSSIDs associated with the one or more APs, the second information being in accordance with the first information indicating the update, and communicate, with the AP, in accordance with the first information and the second information.

Some examples of the method, wireless communication devices, and non-transitory computer-readable medium described herein may further include operations, features, means, or instructions for receiving, via one or more third fields in a later portion of the management frame subsequent to the early portion of the management frame, communication configuration information for the one or more parameters based on determining an applicability of the update to the wireless communication device according to the update information.

Another innovative aspect of the subject matter described in this disclosure can be implemented in a method for wireless communication by an AP. The method may include establishing a communication link with a wireless communication device, transmitting a management frame including: one or more first fields and one or more second fields of a set of multiple fields in an early portion of the management frame, the one or more first fields being earlier in the management frame than the one or more second fields, the one or more first fields including first information related to whether there is an update to one or more parameters associated with one or more BSSIDs associated with one or more APs, the one or more second fields including second information indicating update information associated with the update to the one or more parameters associated with the one or more BSSIDs associated with the one or more APs, the second information being in accordance with the first information indicating the update, and communicating, with the wireless communication device, in accordance with the first information and the second information.

Another innovative aspect of the subject matter described in this disclosure can be implemented in an AP. The AP may include a processing system that includes processor circuitry and memory circuitry that stores code. The processing system may be configured to cause the AP to establish a communication link with a wireless communication device, transmit a management frame including: one or more first fields and one or more second fields of a set of multiple fields in an early portion of the management frame, the one or more first fields being earlier in the management frame than the one or more second fields, the one or more first fields including first information related to whether there is an update to one or more parameters associated with one or more BSSIDs associated with one or more APs, the one or more second fields including second information indicating update information associated with the update to the one or more parameters associated with the one or more BSSIDs associated with the one or more APs, the second information being in accordance with the first information indicating the update, and communicate, with the wireless communication device, in accordance with the first information and the second information.

Another innovative aspect of the subject matter described in this disclosure can be implemented in an AP. The AP may include means for establishing a communication link with a wireless communication device, means for transmitting a management frame including: one or more first fields and one or more second fields of a set of multiple fields in an early portion of the management frame, the one or more first fields being earlier in the management frame than the one or more second fields, the one or more first fields including first information related to whether there is an update to one or more parameters associated with one or more BSSIDs associated with one or more APs, the one or more second fields including second information indicating update information associated with the an update to the one or more parameters associated with the one or more BSSIDs associated with the one or more APs, the second information being in accordance with the first information indicating the update, and means for communicating, with the wireless communication device, in accordance with the first information and the second information.

Another innovative aspect of the subject matter described in this disclosure can be implemented in a non-transitory computer-readable medium storing code. The code may include instructions executable by one or more processors to establish a communication link with a wireless communication device, transmit a management frame including: one or more first fields and one or more second fields of a set of multiple fields in an early portion of the management frame, the one or more first fields being earlier in the management frame than the one or more second fields, the one or more first fields including first information related to whether there is an update to one or more parameters associated with one or more BSSIDs associated with one or more APs, the one or more second fields including second information indicating update information associated with the update to the one or more parameters associated with the one or more BSSIDs associated with the one or more APs, the second information being in accordance with the first information indicating the update, and communicate, with the wireless communication device, in accordance with the first information and the second information.

Some examples of the method, access points (APs), and non-transitory computer-readable medium described herein may further include operations, features, means, or instructions for updating a communication configuration of the AP in accordance with the update to the one or more parameters associated with the one or more BSSIDs, where communicating with the wireless communication device may be in accordance with updating the communication configuration.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example of a signaling diagram that supports early indication of updates to wireless parameters.

FIG. 3 shows an example of a process flow that supports early indication of updates to wireless parameters.

FIG. 4 shows a block diagram of an example wireless communication device that supports early indication of updates to wireless parameters.

FIG. 5 shows a block diagram of an example wireless communication device that supports early indication of updates to wireless parameters.

FIGS. 6 and 7 show flowcharts illustrating example processes performable by or at a wireless communication device that supports early indication of updates to wireless parameters.

FIGS. 8 and 9 show flowcharts illustrating example processes performable by or at an AP that supports early indication of updates to wireless parameters.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communication networks, an access point (AP) device may transmit a management frame (such as a beacon frame) to a wireless communication device (such as a station (STA)). The management frame may include control information for one or more basic service sets (BSSs) associated with one or more respective BSS identifiers (BSSIDs) served by the AP device. The AP device may operate one or more virtual APs, each corresponding to a BSSID. The management frame may include an indication of an update, such as a critical update, for one or more types of wireless communication (such as one or more generations of wireless communication networks). The update may indicate that one or more parameters for a communication configuration at the AP have been updated. The wireless communication device may update one or more parameters for a communication configuration at the wireless communication device in response to the indication of the update. For example, the wireless communication device may update the one or more parameters to maintain a communication link between the wireless communication device and the AP. If the wireless communication device does not receive the management frame, the wireless communication device may communicate with the AP in accordance with an set of outdated parameters. Frame exchanges between the AP and the wireless communication device may be unsuccessful based on the wireless communication device communicating in accordance with the set of outdated parameters.

For example, the update, which may be a critical update, may indicate that the AP is entering a power saving mode. The AP (which may operate in the power saving mode) may communicate with the wireless communication device in response to a wake up frame. If the wireless communication device does not receive the critical update, however, the wireless communication device may not transmit the wake up frame prior to communicating with the AP, and the wireless communication device may communicate with the AP in accordance with a set of outdate parameters. Frame exchange between the AP and the wireless communication device may be unsuccessful based on the wireless communication device not transmitting a wake up frame prior to communicating with the AP. To prevent the wireless communication device from using the set of outdated parameters and performing unsuccessful frame exchange with the AP, the wireless communication device may decode the management frame to determine if the management frame is applicable to the wireless communication device. However, in some examples, the indication of the critical update may be in a later portion of the management frame (e.g., in a second portion of the management frame which follows of an early or first portion of the management frame, not an early portion of the management frame), increasing power consumption at the wireless communication device by decoding a relatively large portion of the management frame before the indication of the critical update. For example, the wireless communication device may decode the entire management frame and determine that the critical update is not applicable to the wireless communication device. Additionally, or alternatively, the wireless communication device may transmit a request, such as a poll request, for communication configuration information for the critical update even if the critical update is not applicable to the wireless communication device. The communication configuration information may include updated parameters (such as updated parameter values) associated with the critical update. But decoding and/or requesting communication configuration information that is not applicable to the wireless communication device may increase power consumption at the wireless communication device and decrease communication efficiency between the wireless communication device and the AP, among other challenges that could be avoided.

Various aspects relate generally to an AP indicating an update (such as a critical update) to a wireless communication device via an early portion of the management frame (e.g., in a first portion of the management frame which is followed by a second or later portion of the management frame). Some aspects more specifically relate to indicating update information to enable the wireless communication device to determine an applicability of the update via an early portion of the management frame. The update information may include context or metadata associated with the update. In some examples, the AP may indicate whether there is an update to one or more parameters associated with one or more BSSIDs related to one or more BSSs in an early portion of the management frame. The early portion of the management frame may include a portion of the management frame prior to and including a traffic indication map (TIM) element. For example, the AP may transmit information that indicates that there is an update, such as a critical update, for a type of wireless communication (such as an ultra-high reliability (UHR) type of wireless communication or a UHR generation, among various examples). The AP may transmit the information that indicates that there is an update via one or more first fields of an early portion of the management frame. The update may be applicable to the wireless communication device based on the wireless communication device supporting the type of wireless communication. The one or more first fields of the early portion of the management frame may include a capability information field, which may include one or more bits indicating whether the management frame includes the update (for example a critical update) for the type of wireless communication. The management frame may include one or more second fields of the early portion of the management frame that indicate an applicability of the update to the wireless communication device. The one or more second fields of the early portion of the management frame may be later in the management frame (such as later in the early portion of the management frame) than the one or more first fields. The one or more second fields of the early portion of the management frame may include the TIM element, which may include update information. The update information may indicate types of wireless communication applicable to the update, communication links applicable to update, and/or one or more APs applicable to the update, among other examples. The wireless communication device may decode a remaining portion of the management frame and/or transmit a poll request for communication configuration information associated with the critical update based on the capability information field and the TIM element indicating a critical update applicable to the wireless communication device. The wireless communication device may communicate with the AP in accordance with the critical update. For example, the wireless communication device may update one or more parameters in accordance with the update (for example a critical update) to maintain the communication link with the AP.

Particular aspects of the subject matter described in this disclosure can be implemented to realize one or more of the following potential advantages. In some examples, by providing update information in an early portion of the management frame, the described techniques can be used to reduce power consumption and streamline processes performed at the wireless communication device. For example, the wireless communication device may refrain from decoding an entire management frame, transmitting a poll request to the AP, and/or refrain from monitoring for a subsequent management frame based on the update information indicating that the update (for example a critical update) is not applicable to the wireless communication device.

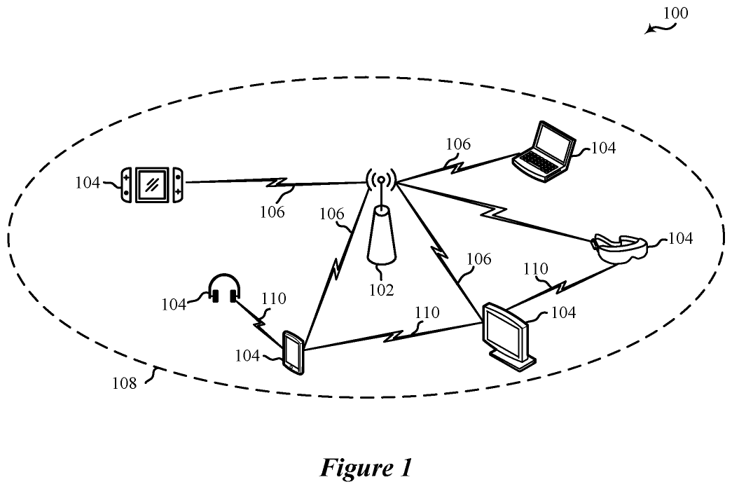

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the 802.11bq Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (such as in an extended service set (ESS) deployment, enterprise network or AP mesh network), or may not include any AP at all (such as in an independent BSS (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as an infrastructure BSS, which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a BSSID, which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHZ, 5 GHZ, 6 GHz, 45 GHZ, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHZ, 5 GHZ, 6 GHZ, 45 GHZ, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHZ-24.25 GHZ), FR4a or FR4-1 (52.6 GHZ-71 GHz), FR4 (52.6 GHz-114.25 GHz), and FR5 (114.25 GHZ-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting UHR communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR- or IEEE 802.11bn-compatible) devices for opportunistic access to spectrum that may be otherwise under-utilized.

In some wireless communication systems, wireless communication devices (such as an AP 102 and STAs 104 described with reference to FIG. 1) may operate via one or more wireless communication links in a frequency band higher than a sub-7 GHz (sub7, such as a 2.4 GHz frequency band, a 5 GHz frequency band, or a 6 GHz frequency band) frequency band. In some such wireless communication systems, the AP 102 and STAs 104 may communicate on a wireless communication link in a millimeter wave (“mmWave” or “mmW”) band (such as a frequency band between 30 GHz and 300 GHz, such as a 60 GHz frequency band). A wireless communication system supporting such mmWave communications (such as AP 102 and STAs 104 in wireless communications network 100) may use integrated mmWave (IMMW) techniques to support operations in these frequency bands. To manage the relatively high attenuation losses and other path losses associated with the mm Wave band, the AP 102 and STAs 104 may transmit and receive directional communications via beamforming procedures. To select or otherwise generate directional beams in the mmWave band, a wireless communication device may perform beam sweeping, searching and training operations, which may involve various training and feedback reporting packet sequences. In some wireless communication systems, a mmWave link supports data communications while a sub7 link may be used for management and control information signaling to support the mmWave communications. For example, a STA 104 may first associate with an AP 102 to establish a sub7 link, and thereafter, perform beam searching and training in the mmWave band to establish a mmWave link for the communication of data. In such examples, the sub7 link may be referred to as an anchor link.

In addition to beam searching and training procedures, an AP 102 and a STA 104, after having selected a beam pair, may perform beam management and recovery procedures, including periodic beacon-based procedures and aperiodic STA-initiated fast link recovery procedures, which may involve the use of beam recovery sequences. The AP 102 and STAs 104 may use these beam management and recovery procedures for beam sync-up and identifying broken links. When communicating via a mmWave link, the AP 102 and STAs 104 may perform various channel access procedures including contention-based access procedures, target wake time (TWT)-based access procedures (including the use of dedicated and opportunistic service periods (SPs)), scheduled-mode access procedures, and triggered-mode access procedures. The APs 102 and STAs 104 operating in the mmWave band also may support various management frame optimizations and procedures including optimizations and procedures associated with discovery, scanning, association, roaming, link setup, updates and maintenance, and the initial and continuing configuration of BSS and link-specific parameters including channel selection and rate adaptation. To support or facilitate communication in the mmWave band, the APs 102 and STAs 104 also may make use of various PHY layer enhancements, such as additional bandwidth modes, numerologies, tone plans, preamble designs, codebook designs, waveform designs, new PPDU formats or reuse of existing sub-7 GHz PPDU formats for mm Wave frequencies. Particular RF and analog designs, such as RF front end designs, antenna integration designs, and conversion architecture designs, may be implemented in APs 102 and STAs 104 to support mmWave operation.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (such as by generating a message integrity check (MIC) for one or more relevant fields.

Some APs and STAs, such as, for example, the AP 102 and STAs 104 described with reference to FIG. 1, are capable of multi-link operation (MLO). For example, the AP 102 and STAs 104 may support MLO as defined in one or both of the IEEE 802.11be and 802.11bn standard amendments. An MLO-capable device may be referred to as a MLD. In some examples, MLO supports establishing multiple different communication links (such as a first link on the 2.4 GHz band, a second link on the 5 GHz band, and the third link on the 6 GHz band) between MLDs. Each communication link may support one or more sets of channels or logical entities. For example, an AP MLD may set, for each of the communication links, a respective operating bandwidth, one or more respective primary channels, and various BSS configuration parameters. An MLD may include a single upper MAC entity, and can include, for example, three independent lower MAC entities and three associated independent PHY entities for respective links in the 2.4 GHz, 5 GHz, and 6 GHz bands. This architecture may enable a single association process and security context. An AP MLD may include multiple APs 102 each configured to communicate on a respective communication link with a respective one of multiple STAs 104 of a non-AP MLD (also referred to as a “STA MLD”).

To support MLO techniques, an AP MLD and a STA MLD may exchange MLO capability information (such as supported aggregation types or supported frequency bands, among other information). In some examples, the exchange of information may occur via a beacon frame, a probe request frame, a probe response frame, an association request frame, an association response frame, another management frame, a dedicated action frame, or an operating mode indicator (OMI), among other examples. In some examples, an AP MLD may designate a specific channel of one link in one of the bands as an anchor channel on which it transmits beacons and other control or management frames periodically. In such examples, the AP MLD also may transmit shorter beacons (such as ones which may contain less information) on other links for discovery or other purposes.

MLDs may exchange packets on one or more of the communications links dynamically and, in some instances, concurrently. MLDs also may independently contend for access on each of the communication links, which achieves latency reduction by enabling the MLD to transmit its packets on the first communication link that becomes available. For example, “alternating multi-link” may refer to an MLO mode in which an MLD may listen on two or more different high-performance links and associated channels concurrently. In an alternating multi-link mode of operation, an MLD may alternate between use of two links to transmit portions of its traffic. Specifically, an MLD with buffered traffic may use the first link on which it wins contention and obtains a TXOP to transmit the traffic. While such an MLD may in some examples be capable of transmitting or receiving on only one communication link at any given time, having access opportunities via two different links enables the MLD to avoid congestion, reduce latency, and maintain throughput.

Multi-link aggregation (MLA) (which also may be referred to as carrier aggregation (CA)) is another MLO mode in which an MLD may simultaneously transmit or receive traffic to or from another MLD via multiple communication links in parallel such that utilization of available resources may be increased to achieve higher throughput. That is, during at least some duration of time, transmissions or portions of transmissions may occur over two or more communication links in parallel at the same time. In some examples, the parallel communication links may support synchronized transmissions. In some other examples, or during some other durations of time, transmissions over the communication links may be parallel, but not be synchronized or concurrent. Additionally, in some examples or durations of time, two or more of the communication links may be used for communications between MLDs in the same direction (such as all uplink or all downlink), while in some other examples or durations of time, two or more of the communication links may be used for communications in different directions (such as one or more communication links may support uplink communications and one or more communication links may support downlink communications). In such examples, at least one of the MLDs may operate in a full duplex mode.

MLA may be packet-based or flow-based. For packet-based aggregation, frames of a single traffic flow (such as all traffic associated with a given traffic identifier (TID)) may be transmitted concurrently across multiple communication links. For flow-based aggregation, each traffic flow (such as all traffic associated with a given TID) may be transmitted using a single respective one of multiple communication links. As an example, a single STA MLD may access a web browser while streaming a video in parallel. Per the above example, the traffic associated with the web browser access may be communicated over a first communication link while the traffic associated with the video stream may be communicated over a second communication link in parallel (such that at least some of the data may be transmitted on the first channel concurrently with data transmitted on the second channel). In some other examples, MLA may be implemented with a hybrid of flow-based and packet-based aggregation. For example, an MLD may employ flow-based aggregation in situations in which multiple traffic flows are created and may employ packet-based aggregation in other situations. Switching among the MLA techniques or modes may additionally, or alternatively, be associated with other metrics (such as a time of day, traffic load within the network, or battery power for a wireless communication device, among other factors or considerations).

Other MLO techniques may be associated with traffic steering and QoS characterization, which may achieve latency reduction and other QoS enhancements by mapping traffic flows having different latency or other requirements to different links. For example, traffic with low latency requirements may be mapped to communication links operating in the 6 GHz band and more latency-tolerant flows may be mapped to communication links operating in the 2.4 GHz or 5 GHz bands. Such an operation, referred to as TID-to-Link mapping (TTLM), may enable two MLDs to negotiate mapping of certain traffic flows in the DL direction or the UL direction or both directions to one or more set of communication links set up between them. In some examples, an AP MLD may advertise a global TTLM that applies to all associated non-AP MLDs. A communication link that has no TIDs mapped to it in either direction is referred to as a disabled link. An enabled link has at least one TID mapped to it in at least one direction.

In some examples, an MLD may include multiple radios and each communication link associated with the MLD may be associated with a respective radio of the MLD. Each radio may include one or more of its own transmit/receive (Tx/Rx) chains, include or be coupled with one or more of its own physical antennas or shared antennas, and include signal processing components, among other components. An MLD with multiple radios that may be used concurrently for MLO may be referred to as a multi-link multi-radio (MLMR) MLD. Some MLMR MLDs may further be capable of an enhanced MLMR (eMLMR) mode of operation, in which the MLD may be capable of dynamically switching radio resources (such as antennas or RF frontends) between multiple communication links (such as switching from using radio resources for one communication link to using the radio resources for another communication link) to enable higher transmission and reception using higher capacity on a given communication link. In this eMLMR mode of operation, MLDs may be able to move Tx/Rx radio resources from one communication link to another link, thereby increasing the spatial stream capability of the other communication link. For example, if a non-AP MLD includes four or more STAs, the STAs associated with the eMLMR links may “pool” their antennas so that each of the STAs can utilize the antennas of other STAs when transmitting or receiving on one of the eMLMR links.

Other MLDs may have more limited capabilities and not include multiple radios. An MLD with only a single radio that is shared for multiple communication links may be referred to as a multi-link single radio (MLSR) MLD. Control frames may be exchanged between MLDs before initiating data or management frame exchanges between the MLDs in cases in which at least one of the MLDs is operating as an MLSR MLD. Because an MLD operating in the MLSR mode is limited to a single radio, it cannot use multiple communication links simultaneously and may instead listen to (such as monitor), transmit or receive on only a single communication link at any given time. An MLSR MLD may instead switch between different bands in a TDM manner. In contrast, some MLSR MLDs may further be capable of an enhanced MLSR (eMLSR) mode of operation, in which the MLD can concurrently listen on multiple links for specific types of packets, such as buffer status report poll (BSRP) frames or multi-user (MU) request-to-send (RTS) (MU-RTS) frames. Although an MLD operating in the eMLSR mode can still transmit or receive on only one of the links at any given time, it may be able to dynamically switch between bands, resulting in improvements in both latency and throughput. For example, when the STAs of a non-AP MLD may detect a BSRP frame on their respective communication links, the non-AP MLD may tune all of its antennas to the communication link on which the BSRP frame is detected. By contrast, a non-AP MLD operating in the MLSR mode can only listen to, and transmit or receive on, one communication link at any given time.

An MLD that is capable of simultaneous transmission and reception on multiple communication links may be referred to as a simultaneous transmission and reception (STR) device. In a STR-capable MLD, a radio associated with a communication link can independently transmit or receive frames on that communication link without interfering with, or without being interfered with by, the operation of another radio associated with another communication link of the MLD. For example, an MLD with a suitable filter may simultaneously transmit on a 2.4 GHz band and receive on a 5 GHz band, or vice versa, or simultaneously transmit on the 5 GHz band and receive on the 6 GHz band, or vice versa, and as such, be considered a STR device for the respective paired communication links. Such an STR-capable MLD may generally be an AP MLD or a higher-end STA MLD having a higher performance filter. An MLD that is not capable of simultaneous transmission and reception on multiple communication links may be referred to as a non-STR (NSTR) device. A radio associated with a given communication link in an NSTR device may experience interference when there is a transmission on another communication link of the NSTR device. For example, an MLD with a standard filter may not be able to simultaneously transmit on a 5 GHz band and receive on a 6 GHz band, or vice versa, and as such, may be considered a NSTR device for those two communication links.

In some wireless communication systems, an MLD may include multiple non-collocated entities. For example, an AP MLD may include non-collocated AP devices and a STA MLD may include non-collocated STA devices. In examples in which an AP MLD includes multiple non-collocated AP devices, a single mobility domain (SMD) entity may refer to a logical entity that controls the associated non-collocated APs. A non-AP STA (such as a non-MLD non-AP STA or a non-AP MLD that includes one or more associated non-AP STAs) may associate with the SMD entity via one of its constituent APs and may seamlessly roam (such as without requiring reassociation) between the APs associated with the SMD entity. The SMD entity also may maintain other context (such as security and Block ACK) for non-AP STAs associated with it.

The afore-mentioned and related MLO techniques may provide multiple benefits to a wireless communication network 100. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the “on” time of a modem, which may benefit a wireless communication device in terms of power consumption. Another benefit of MLO is the increased multiplexing opportunities in the case of a single BSS. For example, MLA may increase the number of users per multiplexed transmission served by the multi-link AP MLD.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (such as APs 102 and STAs 104) to enhance various aspects associated with wireless communication. For example, an AI/ML model may be trained to identify patterns or relationships in data observed in a wireless communication network 100. An AI/ML model may support operational decisions implemented by one or more wireless communication devices relating to aspects described herein that are associated with wireless communications networks or services. For example, an AI/ML model may be utilized for supporting or improving aspects such as reducing signaling overhead (such as by CSI feedback compression, etc.), enhancing roaming or other mobility operations, multi-AP coordination, and generally facilitating network management or optimizing network connections or characteristics to, for example, increase throughput or capacity, reduce latency or otherwise enhance user experience.

According to techniques described herein, the AP 102 may indicate whether there is an update to one or more parameters associated with one or more BSSIDs in an early portion of the management frame. For example, the AP 102 may transmit information that indicate a critical update for a type of a wireless communication (such as an UHR type of wireless communication or a UHR generation) including the wireless communication device via one or more first fields of an early portion of the management frame. The one or more first fields of the early portion of the management frame may include a capability information field, which may include one or more bits indicating whether the management frame includes the critical update for the UHR type of wireless communication.

The management frame may include one or more second fields of the early portion of the management frame that indicate an applicability of the critical update to the wireless communication device. The one or more second fields of the early portion of the management frame may include a TIM element, which may include critical update context information. The critical update context information may indicate types of wireless communication applicable to the update, communication links applicable to update, and/or one or more APs 102 applicable to the update.

The wireless communication device may decode a remaining portion of the management frame and/or transmit a poll request for communication configuration information based on the capability information field and the TIM element indicating a critical update applicable to the wireless communication device. The wireless communication device may communicate with the AP 102 in accordance with the critical update. For example, the wireless communication device may update one or more parameters in accordance with the critical update to maintain the communication link with the AP 102.

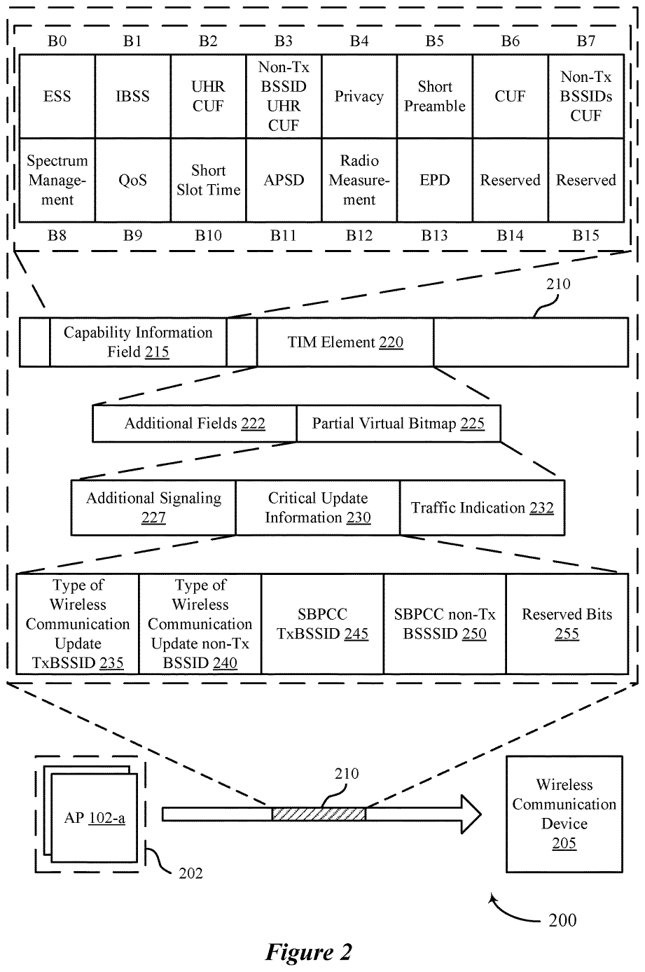

FIG. 2 shows an example of a signaling diagram 200 that supports early indication of updates to wireless parameters. In some examples, signaling diagram 200 may implement aspects of wireless communication network 100. For example, an AP 102-a may represent an example of an AP, such as the AP 102 described with reference to FIG. 1. The AP 102-a may be collocated with one or more additional APs 102. For example, an AP device 202 may serve multiple BSSIDs corresponding to the one or more APs 102, including the AP 102-a. In a multiple BSSID set, the AP device 202 may support multiple APs 102 (such as virtual APs) operating via a same physical device (such as the AP device 202). Although feature and/or action may be described as being performed by the AP 102-a, it should be understood that the AP device 202 may support and/or perform the features and/or actions described in the context of AP 102-a. A wireless communication device 205 may represent an example of the AP 102 or an STA, such as the STA 104 described with reference to FIG. 1. The wireless communication device 205 may support one or more types of wireless communication. For example, the wireless communication device 205 may support or otherwise implement one or more generations of wireless communication. The AP 102-a may transmit (such as via a transmitting BSSID (TxBSSID) of the multiple BSSIDs) a management frame 210 to one or more wireless communication devices. For example, the management frame 210 may be an example of a beacon frame. The wireless communication device 205 may decode at least an early portion of the management frame 210 to determine whether information indicated by the management frame 210 is relevant to the wireless communication device 205.

In some wireless communication systems, the management frame may indicate specific updates for a type (such as generation) of wireless communication. For example, the AP 102-a may indicate a critical update, which may indicate that one or more parameters defining a communication configuration between the AP 102-a and the wireless communication device 205 are changing. In some examples, a mechanism to indicate critical updates via the management frame 210 may be common across multiple types of wireless communication. For example, the AP 102-a may increment a check beacon field in a TIM element 220 (such as TIM frame) in response to an update to an element in a list of critical update elements. The common mechanism may not differentiate updates for different types of wireless communication. A new type may add more elements to the list of critical update elements, thereby increasing the frequency of a critical update. The increased quantity of elements may increase a probability that a wireless communication device 205 supporting an earlier type of wireless communication uses processing resources to read an entire beacon and/or probe the AP. However, the wireless communication device 205 may determine that no change to the parameters applicable to the earlier type of wireless communication are updated by the critical update (such as, the update occurred for parameters that belong to a later type of wireless communication).

For example, a wireless communication device 205 that is in power-save mode may monitor the TIM element 220 (such as TIM frames). The wireless communication device 205 may not monitor additional portions of the management frame 210. The wireless communication device 205 may wake-up during target beacon transmission time (TBTT) to receive the management frame 210 based on the AP 102-a incrementing a check beacon field due to an update to an element in the list of critical update elements.

In some examples, the management frame 210 may support multi-link critical updates, which may further increase a frequency of critical updates (such as the AP 102-a may support extremely high throughput (EHT), which may support multi-link critical updates). For example, the management frame 210 may include an early indication of a critical update in a capability information field 215 to signal an update to a communication link of the AP 102-a in MLD For example, the early indication of the critical update may be included in the management frame 210 prior to one or more later fields subsequent to the early indication.

The capability information field 215 may include a change sequence counter for multiple links and an indication of whether all the updates for another link are included in the beacon. The multiple link may include one or more links for the TxBSSID and/or one or more links for the non-TxBSSID. In some examples, the change sequence counter may account for multiple links (such as for the AP MLD) of the APs 102 in the multiple BSSID set. For example, the AP 102-a may increment a respective change sequence counter after updating a parameter applicable to a link. In some examples, the management frame 210 may include communication configuration information indicating updated parameter values for the critical update, and the wireless communication device 205 may update a communication configuration using the communication configuration information. In some examples, the management frame 210 may not include communication configuration information, and the wireless communication device 205 may receive obtain the communication configuration information via additional signaling.

The management frame 210 may include a relatively large quantity of data (such as beacon bloating). In some examples, in order to reduce the quantity of data in the management frame, the management frame may not include new elements for new types of wireless communication. For example, UHR and above APs may not include new elements defined by UHR and later types of wireless communication in the management frame 210. However, such a scheme may increase a quantity of AP probes (such as lead to a probe storm). For example, multiple wireless communication devices poll the AP 102-a to retrieve a critical update. It may be beneficial for a management frame 210 to identify a type of wireless communication (such as generation) for which an update has occurred (such as for any link). Wireless communication devices belonging to an earlier type of wireless communication may ignore the update if the update is for a later type of wireless communication. The indication of the type of wireless communication may increase power savings and reduce a quantity of wireless communication devices that may query the AP 102-a to retrieve communication configuration information for a critical update.

The indication of a critical update (such as critical updates mechanisms) may enable the wireless communication device 205 to wake up and parse the management frame 210 when critical updates occur and skip parsing the management frame 210 otherwise. Skipping the parsing of the management frames may enable the wireless communication device 205 to conserve power. However, the indication of the critical update may provide an indication of an update after the update has occurred (such as been implemented by the AP 102-a). It may be beneficial for the AP 102-a to provide an advanced notification of upcoming critical updates to the wireless communication device 205. The advanced notification may be beneficial in examples in which the wireless communication device 205 performs certain actions in response to the critical updates. In some examples, UHR APs 102 may provide an advance notification of critical updates.

At a first time, the AP 102-a may start announcing upcoming critical update. For a first duration after the first time, the AP 102-a (such as a UHR AP) may provide advance notification (such as via one or more management frames 210). At a second time after the first duration, the AP 102-a may implement the critical update, and the AP 102-a may communicate in accordance with the critical update. For example, the critical update may occur at the second time. During a second duration after the second time, the AP 102-a may perform announcement of the critical updates (such as inherited by UHR). At a third time after the second duration, the AP 102-a may transmit a management frame 210 (such as a delivery TIM (DTIM) beacon).

The wireless communication device 205 may enter in a deep sleep mode, in which the wireless communication device 205 may not transmit or receive any frames (such as including management frames 210, such as beacon frames) for an extended period (such as several minutes). The wireless communication device 205 may miss all indications of the critical update (such as even with enhancements such as an indication of the type of wireless communication and advance notification). For example, when the wireless communication device 205 wakes up, one or more critical updates (including respective advance notification) may have already occurred and the wireless communication device 205 may miss such updates. The wireless communication device may retrieve the critical update by sending a probe request frame to the AP 102-a.

In UHR (such as due to beacon bloating concerns), the AP 102-a may not advertise parameters of the UHR modes when there are no upcoming critical updates. The management frame 210 may include carry a sum of BSS parameter change count (SBPCC) field in an early portion of the management frame. The SBPCC field in the management frame 210 of the AP 102-a may be affiliated with an AP MLD and indicate a sum of the BSS parameter that have changed for all APs affiliated with the same AP MLD as the AP 102-a. For example, the SBPCC may indicate a quantity of parameters that have been updated during a duration for the AP 102-a and the one or more additional APs 102. The SBPCC field may carry a subset of the bits of the BSS parameter change count field (such as the BPCC of a respective AP 102 may be an 8-bit field but the SBPCC may carry the 3 or 4 least significant bits (LSBs) of the sum).

The various critical updates mechanisms may benefit from one or more indications in an early portion of the management frame 210. It may be beneficial to indicate information related to the critical update via the capability information field 215. The capability information field may be in an early portion of the management frame (such as subsequent to a timestamp and a beacon interval). There may be a limited quantity of bits in the capability information field 215 (such as there are four reserved bits in the capability information field 215). For example, the capability information field may indicate: extended service set (ESS) information via bit 0 (B0), independent BSS (IBSS) information via bit 1 (B1), privacy information via bit 4 (B4), short preamble information via bit 5 (B5), a critical update flag (CUF) via bit 6 (B6), a non-TxBSSID CUF via bit 7 (B7), spectrum management information via bit 8 (B8), quality of service (QoS) information via bit 9 (B9), automatic power save delivery (APSD) information via bit 11 (B11), radio measurement information via bit 12 (B12), ethertype protocol discrimination (EPD) information via bit 13 (B13), and one or more reserved bits (such as bit 2 (B2), bit 3 (B3), bit 14 (B14), and bit 15 (B15)).

According to techniques described herein, the AP 102-a may provide a binary indication of UHR or beyond critical update in the capability information field 215 of the management frame 210 (such as via one or more first fields of an early portion of the management frame 210). A first bit (such as B2 or B14) may indicate UHR critical updates applicable to a TxBSSID. The first bit may be designated as a UHR CUF. A second bit (such as B3 or B15) may indicate UHR critical updates applicable to all non-TxBSSIDs. The second bit may be designated as a Non-TxBSSID UHR CUF. If there is a critical update for a non-TXBSSIDs in the Multi-BSSID set, the second bit may be set to a first logical value (such as 1). The techniques described herein may use two of the four reserved bits in the capability information field. The two remaining bits may be used for additional feature, increasing communication reliability and/or efficiency.

In some examples, a single bit (such as B2, B3, B14, or B15) of the capability information field may indicate UHR critical updates for both the TxBSSID or the non-TxBSSIDs. For example, instead of two bits (such as the first bit for the TxBSSID and the second bit for non-TxBSSIDs), a single bit of the capability information field is defined. Such a bit would be an “or” operation for the TxBSSID bit and non-TxBSSID bit. For example, if there is an update for the TxBSSID and/or one or more non-TxBSSID, the single bit may be set to a first logical value (such as 1).

The AP 102-a may provide detailed information in one or more second fields of the management frame 210 (such as one or more second fields within the early portion of the management frame 210 and subsequent to the one or more first fields). For example, the AP 102-a may provide the detailed information via a quantity of bits of the TIM element 220 (such as 16 bits). As illustrated in FIG. 2, the capability information field 215 may be earlier in the management frame 210 than the TIM element 220. Although initially described in the context of providing the detailed information via 16 bits of the TIM element 220, it should be understood that a quantity of bits may vary (such as 8 bits or 24 bits) and the detailed information may be carried in an element other than TIM element 220.

A range of 16 bits in a partial virtual bitmap 225 of the TIM element 220 may be repurposed as a new field (such as a critical update information field). The critical update information 230 may be in an early portion of the partial virtual bitmap 225. The critical update information 230 may (such as always) be carried in the management frame 210.

For example, the critical update information 230 may be immediately after the multiple BSSID group addressed information carried in the partial virtual bitmap 225. Additionally, or alternatively, the critical update information 230 may be aligned with a start of an octet boundary (such as bit 0 of the critical update information 230 may be one of bit 7, bit 15, bit 23, bit 31, bit 39, bit 47, or bit 55 of the partial virtual bitmap 225. Bit 0 of the critical update information 230 may be based on whether the AP 102-a is part of a multiple BSSID set (such as bit 0 of the critical update information 230 may be bit 47 of the partial virtual bitmap 225) or whether the AP is not part of an MBSSID set (such as bit 0 of the critical update information 230 may be bit 55 of the partial virtual bitmap 225).

The TIM element may include additional fields 222. Additionally, or alternatively, the partial virtual bitmap 225 may include additional signaling 227 and traffic information 232 (such as bits for traffic indication).

The critical update information 230 may include one or more fields. The critical update information 230 may include an indication of a type of wireless communication applicable to an update to one or more parameters for a TxBSSID (such as type of wireless communication update TxBSSID 235 or Generation Update TxBSSID). For example, the type of wireless communication update TxBSSID 235 may indicate a generation and/or type of update for the transmitting AP 102-a. The type of wireless communication update TxBSSID 235 may be two or three bits (such as the type of wireless communication update TxBSSID 235 may span from bit 0 to bit 2 of the critical update information 230).

The type of wireless communication update TxBSSID 235 may indicate one or more types of wireless communication in accordance with Table 1. The one or more types of wireless communication may include an EHT type of wireless communication, a UHR type of wireless communication, and/or a Wi-Fi 9 type of wireless communication. The type of wireless communication applicable to the update may be based on the EHT CUF (such as indicated by B6 of the capability information field 215) and the type of wireless communication update TxBSSID 235.

TABLE 1

| | | Type of Wireless Communication |
|---|---|---|
| Wireless Communication | EHT | Update TxBSSID 235 or Type of |
| Devices affected by the | CUF | Wireless Communication Update |
| one or more updates | (B6) | non-TxBSSID 240 |
| No update | 0 | 000 (0) |
| EHT only | 1 | 000 (0) |
| EHT + UHR | 1 | 001 (1) |
| UHR only | 0 | 001 (1) |
| EHT + Wi-Fi 9 | 1 | 010 (2) |
| EHT + UHR + Wi-Fi 9 | 1 | 001 (1) |
| UHR + Wi-Fi 9 | 0 | 001 (1) |
| Wi-Fi 9 only | 0 | 010 (2) |

For example, the EHT CUF may be set to a first logical value (such as 0), and one or more bits of the type of wireless communication update TxBSSID 235 may be set to a set of logical values (such as 001). The wireless communication device 205 may determine whether the update is applicable to the wireless communication device 205 based on the EHT CUF and the type of wireless communication update TxBSSID 235. In some examples, if the wireless communication device 205 supports UHR, the wireless communication device 205 may decode a later portion of the management frame 210, and/or the wireless communication device 205 may monitor for a second management frame 210 during a TBTT. In some examples, if the wireless communication device 205 does not support UHR, the wireless communication device 205 may not decode a later portion of the management frame 210, and/or the wireless communication device 205 may not monitor for a second management frame 210 during a subsequent TBTT.

The critical update information 230 may include an indication of a type of wireless communication applicable to an update to one or more parameters for the non-TxBSSIDs (such as type of wireless communication update non-TxBSSID 240 or Generation Update non-TxBSSID). For example, the type of wireless communication update non-TxBSSID 240 may indicate a collective generation or type of update for one or more non-transmitting APs 102. Additionally, or alternatively, the type of wireless communication update non-TxBSSID 240 field may include a bitmap indicating which non-TxBSSIDs have an update. The type of wireless communication update non-TxBSSID 240 may indicate the bitmap and not indicate the generation and/or type of the update. The type of wireless communication update non-TxBSSID 240 may be two or three bits (such as the type of wireless communication update non-TxBSSID 240 may span from bit 3 to bit 5 of the critical update information 230). The type of wireless communication update non-TxBSSID 240 may be reserved if the AP 102-a is not configured with multiple BSSIDs.

The type of wireless communication update non-TxBSSID 240 may indicate one or more types of wireless communication in accordance with Table 1. The type of wireless communication applicable to the update may be based on the EHT CUF and the type of wireless communication update non-TxBSSID 240. For example, the EHT CUF may be set to a first logical value (such as 1), and one or more bits of the type of wireless communication update non-TxBSSID 235 may be set to a set of logical values (such as 010). In some examples, such values of the EHT CUF and the type of wireless communication update non-TxBSSID 240 may indicate that a single update is applicable to multiple types of wireless communication (such as EHT and Wi-Fi 9). In some examples, such values of the EHT CUF and the type of wireless communication update non-TxBSSID 240 may indicate that multiple updates are applicable to multiple types of wireless communication. For example, a first update may be applicable to a first type of wireless communication, and a second update may be applicable to a second type of wireless communication. In some examples, the first update may be applicable to a first non-TxBSSID of a first AP 102, and the second update may be applicable to a second non-TxBSSID of a second AP.

The critical update information 230 may include an indication of a quantity of updates applicable to the TxBSSID (such as SBPCC TxBSSID 245). For example, the critical update information 230 may include a SBPCC for the AP MLD of the TxBSSID, which may be a counter. The AP 102-a may increment the counter in response to an update to any link of the AP MLD. The SBPCC TxBSSID 245 may be two or three bits (such as the SBPCC TxBSSID 245 may span from bit 6 to bit 8 of the critical update information 230).

The critical update information 230 may include an indication of a quantity of updates applicable to one or more non-TxBSSIDs (such as SBPCC non-TxBSSID 250). For example, the critical update information may include a SBPCC for the AP MLDs (such as all the non-TxBSSID), which may be a counter. The AP 102-a may increment the counter in response to an update to any link of any AP MLD for any non-TxBSSID in the multiple BSSID set. The SBPCC non-TxBSSID 250 may be two or three bits (such as the SBPCC non-TxBSSID 250 may span from bit 9 to bit 11 of the critical update information 230). In some examples, the SBPCC non-TXBSSID 250 may include a relatively larger quantity of bits (such as more than three bits) based on the AP 102-a incrementing the non-TxBSSID more often. The remaining fields may be reserved (such as bit 12 through bit 15 of the critical update information 230 may be reserved bits 255).

The critical update information 230 may start at a relatively early location within the partial virtual bitmap 225. To enable the critical update information 230 to be located at an early location, the AP 102-a may limit a size of multiple BSSID set. For example, an n value may be a quantity of bits allocated to indicate a size of the multiple BSSID set. In some examples, the n value may be eight, which may indicate 2ⁿ=256 BSSIDs. In practice the multiple BSSID set may be smaller. For example, multiple BSSID sets may include 16 to 32 BSSIDs. In some implementations, a quantity of BSSIDs may be limited to four (n=2). In practice, n=4 may be sufficient. By limiting the size of the multiple BSSID set the critical update information 230 may be indicated via an earlier portion of the partial virtual bitmap 225. For example, a quantity of bits included in the critical update information 230 may be greater than 15 (such as beyond 15 bits may be available).

As described herein, the management frame 210 may include an advanced indication of a critical update. For example, when a mode status and/or a parameter change occurs the AP 102-a (such as a UHR AP) may announce the update in advance of an implementation of the update. When multiple updates occur, the AP 102-a may indicate an advance notification for each update. The AP 102-a may support two types of updates: synchronous and asynchronous updates.

Synchronous updates may be relatively less time dependent (such as time critical). The AP 102-a may delay (such as club) multiple synchronous updates to occur at a same time. For example, the synchronous updates may be flexible as to when the synchronous updates are signaled. Asynchronous updates may be relatively more time dependent. For example, the AP 102-a may not delay asynchronous updates. The AP 102-a may announce the asynchronous updates within a threshold duration or as soon as possible (such as immediately).

In some examples, if multiple synchronous updates occur at the AP 102-a, the AP 102-a may announce the multiple synchronous updates at a same time. The multiple synchronous updates may be implemented (such as take effect) at the same time. Some types of wireless communication (such as UHR) may include synchronous updates and not include asynchronous updates (such as excluding baseline asynchronous updates such as a channel switch announcement (CSA)).

In some examples, one or more increased critical updates of the critical updates may be more time critical than the other updates. The AP may provide notification of the one or more increased critical updates at an earliest possible time (such as via one or more asynchronous updates). For example, the AP 102-a may be unable to delay some urgent updates to be transmitted with other critical updates. An asynchronous critical update may occur while the AP is already advertising the synchronous critical updates. The wireless communication device 205 may not expect to receive a critical update until the synchronous critical updates.

The AP 102-a may provide a countdown (such as counter) of the advance notification in the early portion of the management frame 210. In some examples, the AP 102-a may indicate the countdown via one or more bits of the reserved bits 255 of the critical update information 230. In some examples, the four reserved bits of the capability information field 215 (such as B2, B3, B14, and B15) may all be repurposed for the countdown. There may be no binary indicators for UHR CUF and/or Non-TxBSSID UHR CUF. Instead, a nonzero counter value may indicate that the wireless communication device 205 (such as non-AP STA) may decode the critical update information 230 in the partial virtual bitmap 225 to obtain detailed information related to a critical update.

When the synchronous critical update is expected, the AP 102-a starts the advance notification by initializing the counter to an initial value (such as 10). In subsequent management frames 210, the AP 102-a decrements the value by one, until the counter reaches zero (such as at which point the update takes effect and/or is implemented by the AP 102-a).

The wireless communication device 205 may be expected to receive and parse all the management frames 210 while the advanced notification is ongoing. If an asynchronous critical update is expected (such as implemented), the AP 102-a resets the counter to the initial value (such as 10). If in a management frame, the wireless communication device 205 receives a counter value that is greater than a previously received counter value, the wireless communication device 205 may determine that an asynchronous critical update is impending. For example, the wireless communication device 205 may determine that the asynchronous critical update is included in the management frame 210 or that the asynchronous critical update is going to be included in a subsequent management frame 210.

The management frame 210 may include an all updates included (AUI) flag (such as a UHR AUI flag) to indicate whether UHR updates re included within the management frame 210. For example, the AUI flag may indicate whether the management frame 210 is complete or not (such as whether the management frame 210 carries all the parameters and/or communication configuration information for a critical update). The management frame may include a UHR AUI flag for the reporting AP 102-a and the reported APs (such as APs 102 other than the transmitting AP 102-a whose information is reported in the management frame 210). The UHR AUI may be included in one or more fields of the early portion of the management frame 210. In some examples, the UHR AUI for the reporting AP may be included in the critical update information 230 of the partial virtual bitmap (such as via reserved bits 255) or the capability information field 215 (such as via reserved bits 14 and 15). In some examples, the UHR AUI for the reported APs may be included in the MLD Parameters field of the reduced neighbor report element in the TBTT information field corresponding to the reported AP. In some examples, the UHR AUI for the reported APs may be included in the non-TxBSSID capability element or the critical update information 230 of the partial virtual bitmap 225.

In some examples, the information in the TIM element 220 (such as the second information) may be affected (such as present or modified) based on the capability information field 215 (such as a first indicator in the capability information field 215, such as the UHR CUF). For example, the inclusion of some information and/or fields in the TIM element 220 may be based on the capability information field 215. The non-TxBSSID UHR CUF may indicate that there is an update to at least one non-TxBSSID. The non-TxBSSID UHR CUF also may indicate a presence of a bitmap in the TIM element 220. The presence of a type of update information in the TIM element 220 and/or capability information field 215 may indicate a presence of an update for at least one link. The corresponding counter for the link carried in a later portion of the management frame may be incremented based on the presence of the update for a least one link.

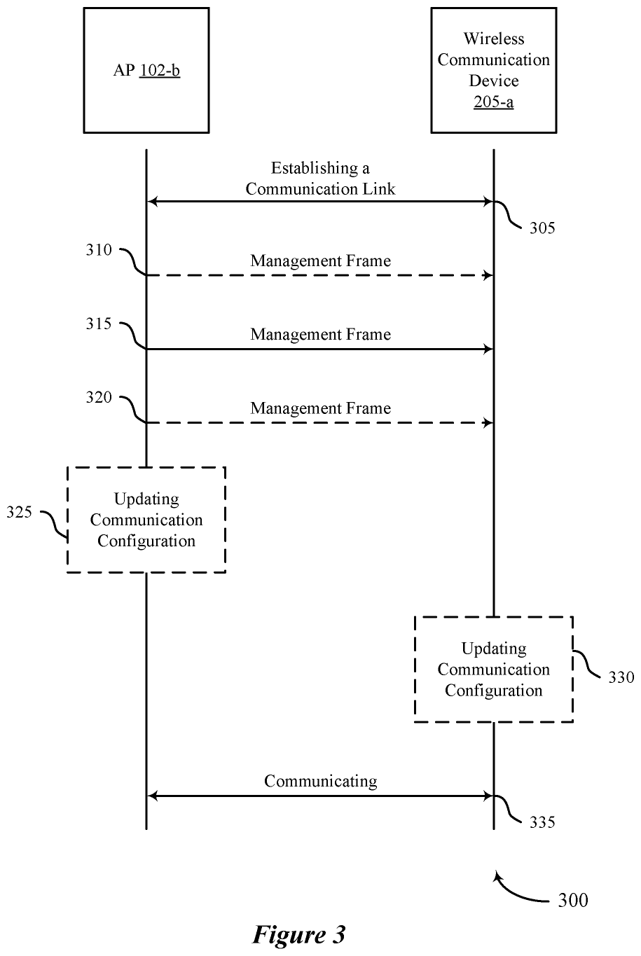

FIG. 3 shows an example of a process flow 300 that supports early indication of updates to wireless parameters. In some examples, process flow 300 may implement aspects of, or be implemented by aspects of, the wireless communication network 100 and/or the signaling diagram 200. For example, the AP 102-b or the wireless communication device 205-a may be examples of corresponding devices described with reference to FIGS. 1 and 2.

At 305, the wireless communication device 205-a and the AP 102-b may establish a communication link.

At 310 the AP 102-b may transmit, and the wireless communication device 205-a may receive, prior to a transmission and/or a reception of the management frame at operation 315, a second management frame including third information indicating a second counter indicating a second quantity of management frames until implementation of the update to the one or more parameters. The second counter may be in accordance with a second update timeline for the update to the one or more parameters different than the first update timeline.

At 315, the AP 102-b may transmit, and the wireless communication device 205-a may receive, a management frame comprising one or more first fields and one or more second fields of a plurality of fields in an early portion of the management frame. The one or more first fields may be earlier in the management frame than the one or more second fields. The one or more first fields may include first information related to whether there is an update to one or more parameters associated with one or more BSSIDs associated with the one or more APs. The one or more second fields may include second information indicating update information associated with the update to the one or more parameters associated with the one or more BSSIDs associated with the one or more APs. The second information may be in accordance with the first information.

In some examples, the one or more first fields may include a capability information field (such as the capability information field 215), and the one or more second fields may include at least a portion of a TIM element (such as the TIM element 220). In some examples, the one or more first fields may include the capability information field and at least a portion of the TIM element, and the one or more second fields may be included within a later portion of the management frame. The one or more second fields in the later portion of the management frame may include a reduced neighbor report, a multi-link element, UHR parameters update element, additional fields subsequent to the TIM element, and/or any combination thereof. The early portion of the management frame may refer to a portion of the management frame including the capability information field and the TIM element. The management frame may be a beacon frame.

In some examples, the AP 102-b may transmit, and the wireless communication device 205-a may receive, via the second information, a bitmap indicating a set of types of one or more wireless communication networks that is applicable to the update to the one or more parameters associated with the one or more BSSIDs. The update to the one or more parameters associated with the one or more BSSIDs may be in accordance with one or more types supported by the wireless communication device 205-a including (such as supporting) at least one type of the set of types.

In some examples, the AP 102-b may transmit, and the wireless communication device 205-a may receive, via the second information, a bitmap indicating one or more communication links to which the update to the one or more parameters applies.

In some examples, the AP 102-b may transmit, and the wireless communication device 205-a may receive, via the second information, a bitmap indicating a subset of the one or more BSSIDs to which the update to the one or more parameters applies.

In some examples, the AP 102-b may transmit, and the wireless communication device 205-a may receive, via the second information, a first indication of a first quantity of updates to a first set of parameters indicating a first communication configuration of the wireless communication device. The first set of parameters may include the one or more parameters. In some examples, the AP 102-b may transmit, and the wireless communication device 205-a may receive, via the second information, a second indication of a second quantity of updates to a second set of parameters indicating a second communication configuration of the wireless communication device. The first communication configuration may be in accordance with the communication link and the second communication configuration may be in accordance with a second communication link.

In some examples, the AP 102-b may transmit, and the wireless communication device 205-a may receive, via the second information, an indication of a first counter indicating a first quantity of management frames until implementation of the update to the one or more parameters associated with the one or more BSSIDs. The first counter may be in accordance with a first update timeline for the update to the one or more parameters. The second information may indicate an asynchronous update to at least the one or more parameters associated with the one or more BSSIDs in accordance with the second quantity of the second counter (such as communicated at operation 310) being less than the first quantity of the first counter.

In some examples, the AP 102-b may transmit, and the wireless communication device 205-a may receive, one or more indications that the communication configuration information is included in the management frame, such as an “all updates included” (AUI) indication that the management frame includes updated parameter information. In some examples, the AP 102-b may transmit, and the wireless communication device 205-a may receive, via one or more third fields in a later portion of the management frame subsequent to the early portion of the management frame, communication configuration information for the one or more parameters. The AP 102-b may transmit, and the wireless communication device 205-a may receive, the communication configuration information via the one or more third fields in the later portion of the management frame in accordance with the one or more indications that the communication configuration information is included in the management frame.

At 320, the AP 102-b may transmit, and the wireless communication device 205-a may receive, a management frame including communication configuration information for the one or more parameters. The AP 102-b may transmit, and the wireless communication device 205-a may receive, the second management frame in accordance with the first information and the second information indicating the update to the one or more parameters.

At 325, the AP 102-b may update a communication configuration of the AP 102-b in accordance with the update to the one or more parameters associated with the one or more BSSIDs.

At 330, the wireless communication device 205-a may update a communication configuration of the wireless communication device 205-a in accordance with the communication configuration information for the one or more parameters.

In some examples, the wireless communication device 205-a may maintain a communication configuration of the wireless communication device 205-a in accordance with the first information and the second information indicating that no parameters of the one or more parameters associated with the one or more BSSIDs are scheduled for an update within a duration.

At 335, the wireless communication device 205-a and the AP 102-b may communicate in accordance with the first information and the second information. The wireless communication device 205—may communicate with the AP 102-b in accordance with updating the communication configuration at operation 325 or updating the communication configuration at operation 330.

In some examples, the update to the one or more parameters may be in accordance with one or more types of a wireless communication network including the wireless communication device 205-a or in accordance with one or more features supported by the wireless communication device 205-a.

As used herein, “early” may be interpreted as describing the relative location of an object or element within a set or structure. For example, an “early a” may imply that one or more “later b” exist following or otherwise subsequent to the “a” in the set and/or structure. As used herein, an “early portion of the management frame” may refer to a portion and/or set of fields in the management frame prior to another portion of the management frame. For example, the “early portion of the management frame” may be prior to communication configuration information indicating updated values of one or more parameters for the critical update. Additionally, or alternatively, an “early portion of the management frame” may refer to a portion of the management frame within or prior to the TIM element (such as the TIM element 220). For example, a capability information field (such as capability information field 215) and/or the TIM element may be consider within an early portion of the management frame. A reduced neighbor report element and/or a multi-link element may be considered in a later portion of the management frame.

The early portion of the management frame may include a first portion (such as one or more first fields) and a second portion (such as one or more second fields). For example, the first portion may include the capability information field, and the second portion may include the TIM element.

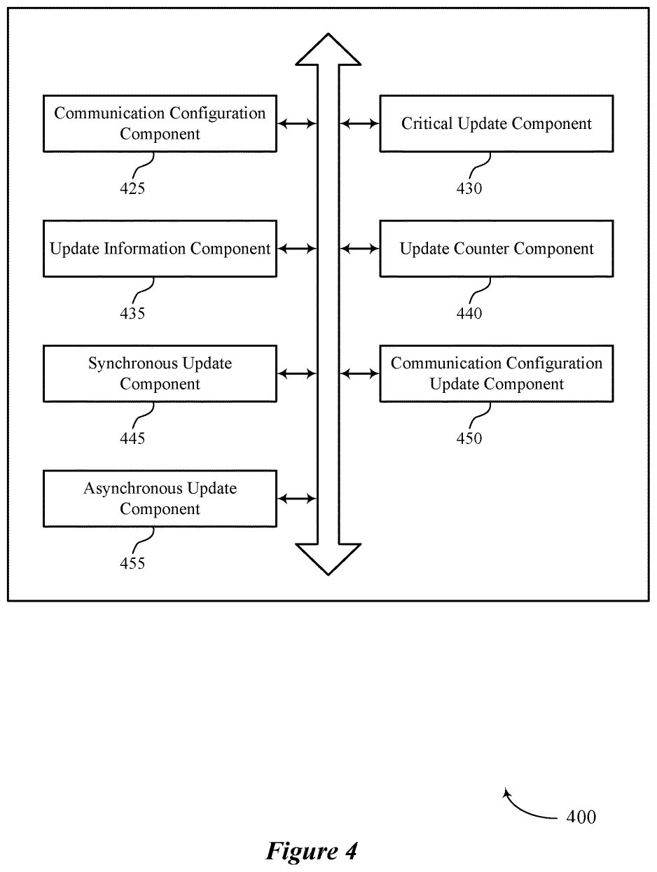

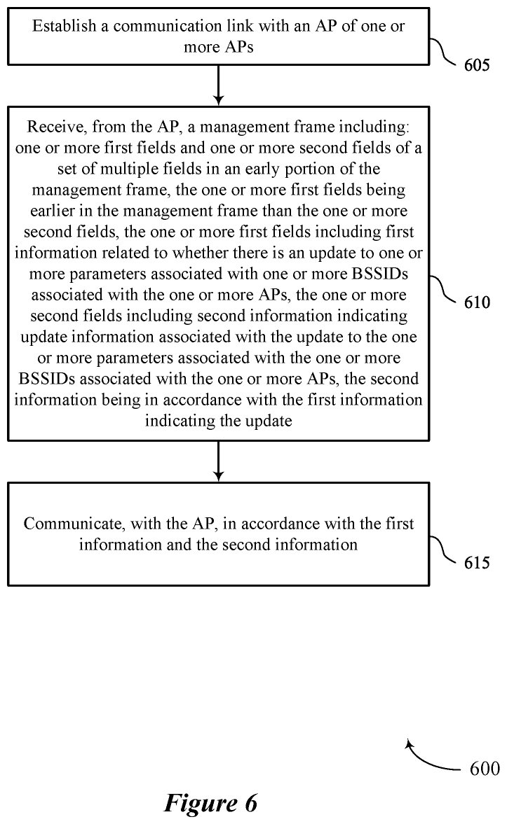

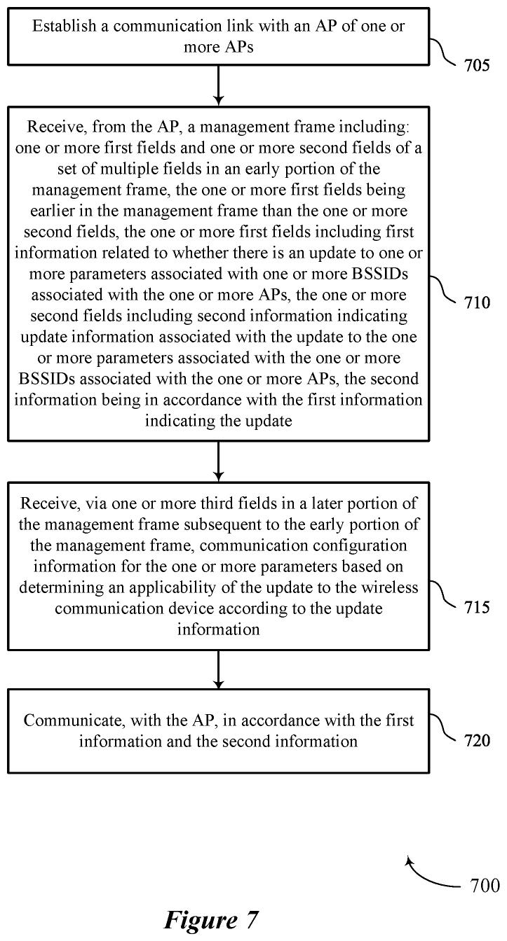

FIG. 4 shows a block diagram of an example wireless communication device 400 that supports early indication of updates to wireless parameters. In some examples, the wireless communication device 400 is configured to perform the processes 600 and 700 described with reference to FIGS. 6 and 7, respectively. The wireless communication device 400 may include one or more chips, SoCs, chipsets, packages, components or devices that individually or collectively constitute or include a processing system. The processing system may interface with other components of the wireless communication device 400, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 400 may transmit the information output from the chip. In such an example, the second interface may refer to an interface between the processing system of the chip and a reception component, such that the wireless communication device 400 may receive information that is then passed to the processing system. In some such examples, the first interface also may obtain information, such as from the transmission component, and the second interface also may output information, such as to the reception component.

The processing system of the wireless communication device 400 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 400 can be configurable or configured for use in a STA, such as the STA 104 described with reference to FIG. 1. In some other examples, the wireless communication device 400 can be a STA that includes such a processing system and other components including multiple antennas. The wireless communication device 400 is capable of transmitting and receiving wireless communications in the form of, for example, wireless packets. For example, the wireless communication device 400 can be configurable or configured to transmit and receive packets in the form of physical layer PPDUs and MPDUs conforming to one or more of the IEEE 802.11 family of wireless communication protocol standards. In some other examples, the wireless communication device 400 can be configurable or configured to transmit and receive signals and communications conforming to one or more 3GPP specifications including those for 5G NR or 6G. In some examples, the wireless communication device 400 also includes or can be coupled with one or more application processors which may be further coupled with one or more other memories. In some examples, the wireless communication device 400 further includes a user interface (UI) (such as a touchscreen or keypad) and a display, which may be integrated with the UI to form a touchscreen display that is coupled with the processing system. In some examples, the wireless communication device 400 may further include one or more sensors such as, for example, one or more inertial sensors, accelerometers, temperature sensors, pressure sensors, or altitude sensors, that are coupled with the processing system.

The wireless communication device 400 includes a Communication Configuration Component 425, a Critical Update Component 430, an Communication Configuration Information Component 435, an Update Counter Component 440, a Synchronous Update Component 445, a Communication Configuration Update Component 450, and an Asynchronous Update Component 455. Portions of one or more of the Communication Configuration Component 425, the Critical Update Component 430, the Communication Configuration Information Component 435, the Update Counter Component 440, the Synchronous Update Component 445, the Communication Configuration Update Component 450, and the Asynchronous Update Component 455 may be implemented at least in part in hardware or firmware. For example, one or more of the Communication Configuration Component 425, the Critical Update Component 430, the Communication Configuration Information Component 435, the Update Counter Component 440, the Synchronous Update Component 445, the Communication Configuration Update Component 450, and the Asynchronous Update Component 455 may be implemented at least in part by at least a processor or a modem. In some examples, portions of one or more of the Communication Configuration Component 425, the Critical Update Component 430, the Communication Configuration Information Component 435, the Update Counter Component 440, the Synchronous Update Component 445, the Communication Configuration Update Component 450, and the Asynchronous Update Component 455 may be implemented at least in part by a processor and software in the form of processor-executable code stored in memory.

The wireless communication device 400 may support wireless communication in accordance with examples as disclosed herein. The Communication Configuration Component 425 is configurable or configured to cause the wireless communication device 400 to establish a communication link with an access point (AP) of one or more APs. The Critical Update Component 430 is configurable or configured to cause the wireless communication device 400 to receive, from the AP, a management frame including: one or more first fields and one or more second fields of a set of multiple fields in an early portion of the management frame, the one or more first fields being earlier in the management frame than the one or more second fields, the one or more first fields including first information related to whether there is an update to one or more parameters associated with one or more BSSIDs associated with the one or more APs, the one or more second fields including second information indicating update information associated with the update to the one or more parameters associated with the one or more BSSIDs associated with the one or more APs, the second information being in accordance with the first information. In some examples, the Communication Configuration Component 425 is configurable or configured to cause the wireless communication device 400 to communicate, with the AP, in accordance with the first information and the second information.

In some examples, the Communication Configuration Information Component 435 is configurable or configured to cause the wireless communication device 400 to receive, via one or more third fields in a later portion of the management frame subsequent to the early portion of the management frame, communication configuration information for the one or more parameters.

In some examples, the Communication Configuration Update Component 450 is configurable or configured to cause the wireless communication device 400 to update a communication configuration of the wireless communication device in accordance with the communication configuration information for the one or more parameters. Communicating with the AP may be in accordance with updating the communication configuration.

In some examples, the Communication Configuration Information Component 435 is configurable or configured to cause the wireless communication device 400 to receive, from the AP, one or more indications that the communication configuration information is included in the management frame. Receiving the communication configuration information via the one or more third fields in the later portion of the management frame may be in accordance with the one or more indications that the communication configuration information is included in the management frame.

In some examples, the Communication Configuration Information Component 435 is configurable or configured to cause the wireless communication device 400 to receive, from the AP, a second management frame including communication configuration information for the one or more parameters. Receiving the second management frame may be in accordance with the first information and the second information indicating the update to the one or more parameters.

In some examples, the Critical Update Component 430 is configurable or configured to cause the wireless communication device 400 to receive, from the AP and via the second information, a bitmap indicating a set of types of one or more wireless communication networks that is applicable to the update to the one or more parameters associated with the one or more BSSIDs. The update to the one or more parameters associated with the one or more BSSIDs may be in accordance with one or more types supported by the wireless communication device including at least one type of the set of types.

In some examples, the Critical Update Component 430 is configurable or configured to cause the wireless communication device 400 to receive, from the AP and via the second information, a bitmap indicating one or more communication links to which the update to the one or more parameters applies.

In some examples, the Critical Update Component 430 is configurable or configured to cause the wireless communication device 400 to receive, from the AP and via the second information, a bitmap indicating a subset of the one or more BSSIDs to which the update to the one or more parameters applies.

In some examples, the Update Counter Component 440 is configurable or configured to cause the wireless communication device 400 to receive, from the AP and via the second information, a first indication of a first quantity of updates to a first set of multiple parameters indicating a first communication configuration of the wireless communication device. The first set of multiple parameters may include the one or more parameters.

In some examples, the Update Counter Component 440 is configurable or configured to cause the wireless communication device 400 to receive, from the AP and via the second information, a second indication of a second quantity of updates to a second set of multiple parameters indicating a second communication configuration of the wireless communication device. The first communication configuration may be in accordance with the communication link and the second communication configuration is in accordance with a second communication link.

In some examples, the Synchronous Update Component 445 is configurable or configured to cause the wireless communication device 400 to receive, from the AP and via the second information, an indication of a first counter indicating a first quantity of management frames until implementation of the update to the one or more parameters associated with the one or more BSSIDs. The first counter may be in accordance with a first update timeline for the update to the one or more parameters.

In some examples, the Asynchronous Update Component 455 is configurable or configured to cause the wireless communication device 400 to receive, prior to a reception of the management frame, a second management frame including third information indicating a second counter indicating a second quantity of management frames until implementation of the update to the one or more parameters. The second counter may be in accordance with a second update timeline for the update to the one or more parameters different than the first update timeline. The second information may indicate an asynchronous update to at least the one or more parameters associated with the one or more BSSIDs in accordance with the second quantity of the second counter being less than the first quantity of the first counter.

In some examples, the Communication Configuration Component 425 is configurable or configured to cause the wireless communication device 400 to maintain a communication configuration of the wireless communication device in accordance with the first information and the second information indicating that no parameters of the one or more parameters associated with the one or more BSSIDs are scheduled for an update within a duration.

In some examples, the one or more first fields include a capability information field. In some examples, the one or more second fields include at least a portion of a timing indication map. In some examples, a first quantity of bits associated with the first information may be greater than a second quantity of bits associated with the second information. In some examples, the management frame is a beacon frame.

In some examples, the update to the one or more parameters is in accordance with one or more types of a wireless communication network including the wireless communication device or in accordance with one or more features supported by the wireless communication device.

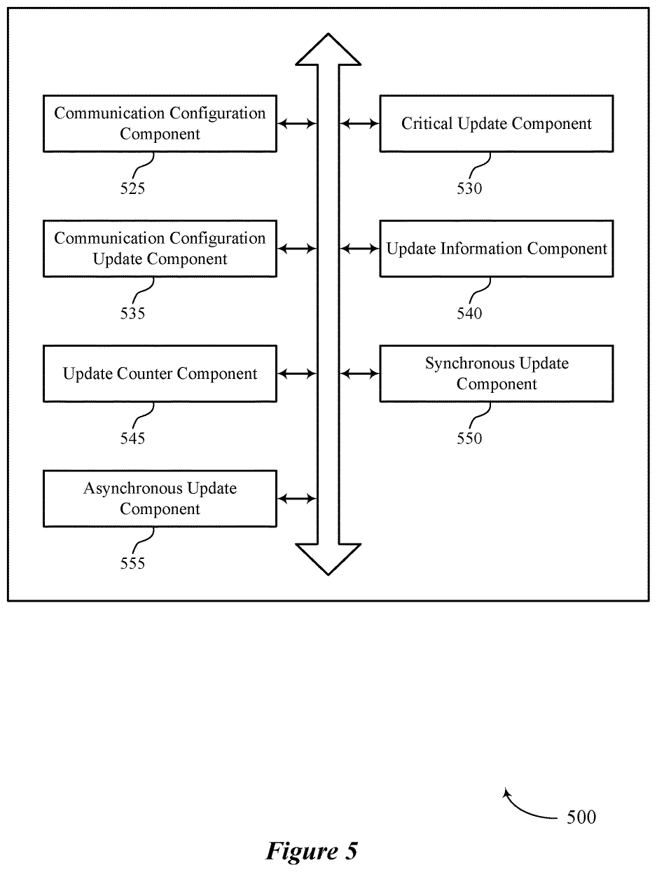

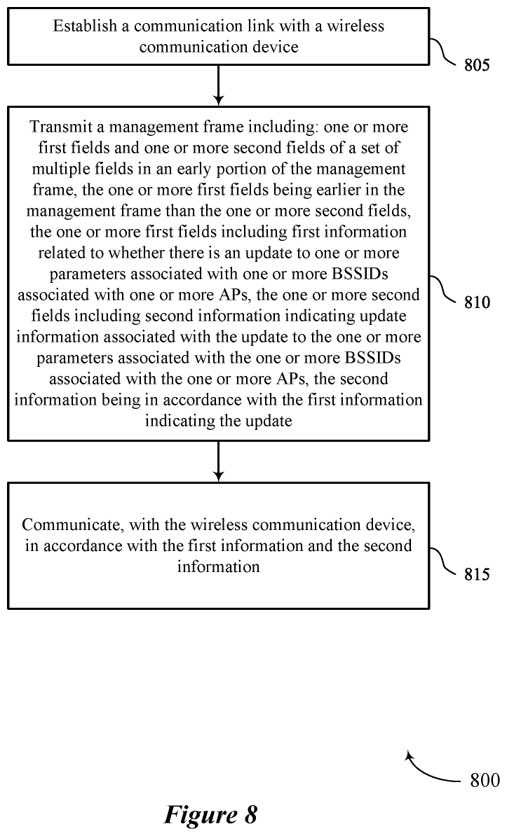

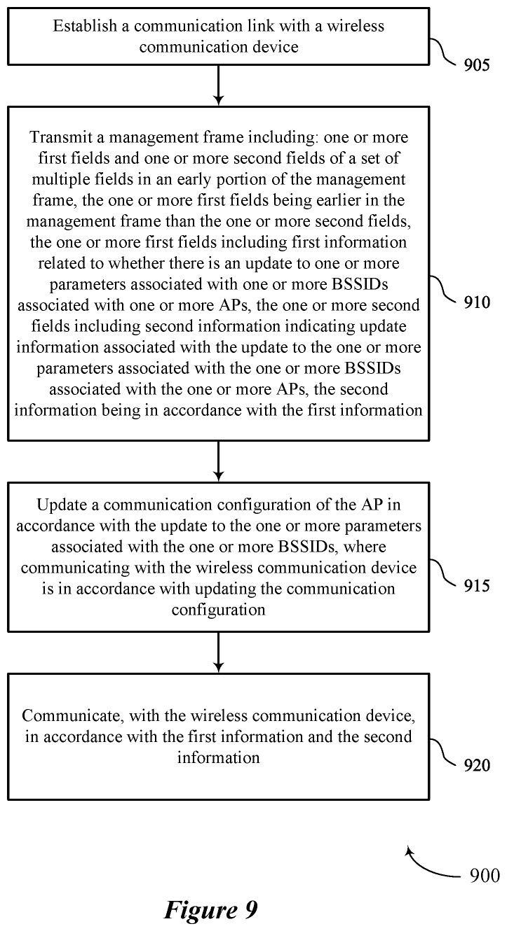

FIG. 5 shows a block diagram of an example wireless communication device 500 that supports early indication of updates to wireless parameters. In some examples, the wireless communication device 500 is configured to perform the processes 800 and 900 described with reference to FIGS. 8 and 9, respectively. The wireless communication device 500 may include one or more chips, SoCs, chipsets, packages, components or devices that individually or collectively constitute or include a processing system. The processing system may interface with other components of the wireless communication device 500, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 500 may transmit the information output from the chip. In such an example, the second interface may refer to an interface between the processing system of the chip and a reception component, such that the wireless communication device 500 may receive information that is then passed to the processing system. In some such examples, the first interface also may obtain information, such as from the transmission component, and the second interface also may output information, such as to the reception component.

The processing system of the wireless communication device 500 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 500 can be configurable or configured for use in an AP, such as the AP 102 described with reference to FIG. 1. In some other examples, the wireless communication device 500 can be an AP that includes such a processing system and other components including multiple antennas. The wireless communication device 500 is capable of transmitting and receiving wireless communications in the form of, for example, wireless packets. For example, the wireless communication device 500 can be configurable or configured to transmit and receive packets in the form of physical layer PPDUs and MPDUs conforming to one or more of the IEEE 802.11 family of wireless communication protocol standards. In some other examples, the wireless communication device 500 can be configurable or configured to transmit and receive signals and communications conforming to one or more 3GPP specifications including those for 5G NR or 6G. In some examples, the wireless communication device 500 also includes or can be coupled with one or more application processors which may be further coupled with one or more other memories. In some examples, the wireless communication device 500 further includes at least one external network interface coupled with the processing system that enables communication with a core network or backhaul network that enables the wireless communication device 500 to gain access to external networks including the Internet.

The wireless communication device 500 includes a Communication Configuration Component 525, a Critical Update Component 530, a Communication Configuration Update Component 535, an Communication Configuration Information Component 540, an Update Counter Component 545, a Synchronous Update Component 550, and an Asynchronous Update component 555. Portions of one or more of the Communication Configuration Component 525, the Critical Update Component 530, the Communication Configuration Update Component 535, the Communication Configuration Information Component 540, the Update Counter Component 545, the Synchronous Update Component 550, and the Asynchronous Update component 555 may be implemented at least in part in hardware or firmware. For example, one or more of the Communication Configuration Component 525, the Critical Update Component 530, the Communication Configuration Update Component 535, the Communication Configuration Information Component 540, the Update Counter Component 545, the Synchronous Update Component 550, and the Asynchronous Update component 555 may be implemented at least in part by at least a processor or a modem. In some examples, portions of one or more of the Communication Configuration Component 525, the Critical Update Component 530, the Communication Configuration Update Component 535, the Communication Configuration Information Component 540, the Update Counter Component 545, the Synchronous Update Component 550, and the Asynchronous Update component 555 may be implemented at least in part by a processor and software in the form of processor-executable code stored in memory.

The wireless communication device 500 may support wireless communication in accordance with examples as disclosed herein. The Communication Configuration Component 525 is configurable or configured to establish a communication link with a wireless communication device. The Critical Update Component 530 is configurable or configured to transmit a management frame including: one or more first fields and one or more second fields of a set of multiple fields in an early portion of the management frame, the one or more first fields being earlier in the management frame than the one or more second fields, the one or more first fields including first information related to whether there is an update to one or more parameters associated with one or more BSSIDs associated with one or more APs, the one or more second fields including second information indicating update information associated with the update to the one or more parameters associated with the one or more BSSIDs associated with the one or more APs, the second information being in accordance with the first information indicating the update. In some examples, the Communication Configuration Component 525 is configurable or configured to communicate, with the wireless communication device, in accordance with the first information and the second information.

In some examples, the Communication Configuration Update Component 535 is configurable or configured to update a communication configuration of the AP in accordance with the update to the one or more parameters associated with the one or more BSSIDs. Communicating with the wireless communication device may be in accordance with updating the communication configuration.

In some examples, the Communication Configuration Information Component 540 is configurable or configured to transmit, via one or more third fields in a later portion of the management frame subsequent to the early portion of the management frame, communication configuration information for the one or more parameters.

In some examples, the Communication Configuration Information Component 540 is configurable or configured to transmit one or more indications that the communication configuration information is included in the management frame. Transmitting the communication configuration information via the one or more third fields in the later portion of the management frame may be in accordance with the one or more indications that the communication configuration information is included in the management frame.

In some examples, the Communication Configuration Information Component 540 is configurable or configured to transmit a second management frame including communication configuration information for the one or more parameters. Transmitting the second management frame may be in accordance with the first information and the second information indicating the update to the one or more parameters.

In some examples, the Critical Update Component 530 is configurable or configured to transmit, via the second information, a bitmap indicating a set of types of one or more wireless communication networks that is applicable to the update to the one or more parameters associated with the one or more BSSIDs. The update to the one or more parameters associated with the one or more BSSIDs may be in accordance with one or more types supported by the wireless communication device including at least one type of the set of types.

In some examples, the Critical Update Component 530 is configurable or configured to transmit, via the second information, a bitmap indicating one or more communication links to which the update to the one or more parameters applies.

In some examples, the Critical Update Component 530 is configurable or configured to transmit, via the second information, a bitmap indicating a subset of the one or more BSSIDs to which the update to the one or more parameters applies.

In some examples, the Update Counter Component 545 is configurable or configured to transmit, via the second information, a first indication of a first quantity of updates to a first set of multiple parameters indicating a first communication configuration of the wireless communication device. The first set of multiple parameters may include the one or more parameters.

In some examples, the Update Counter Component 545 is configurable or configured to transmit, via the second information, a second indication of a second quantity of updates to a second set of multiple parameters indicating a second communication configuration of the wireless communication device. The first communication configuration may be in accordance with the communication link and the second communication configuration is in accordance with a second communication link.

In some examples, the Synchronous Update Component 550 is configurable or configured to transmit, via the second information, an indication of a first counter indicating a first quantity of management frames until implementation of the update to the one or more parameters associated with the one or more BSSIDs. The first counter may be in accordance with a first update timeline for the update to the one or more parameters.

In some examples, the Asynchronous Update component 555 is configurable or configured to transmit, prior to a reception of the management frame, a second management frame including third information indicating a second counter indicating a second quantity of management frames until implementation of the update to the one or more parameters. The second counter may be in accordance with a second update timeline for the update to the one or more parameters different than the first update timeline. The second information may indicate an asynchronous update to at least the one or more parameters associated with the one or more BSSIDs in accordance with the second quantity of the second counter being less than the first quantity of the first counter.

In some examples, the one or more first fields include a capability information field. In some examples, the one or more second fields include at least a portion of a timing indication map. In some examples, a first quantity of bits associated with the first information is greater than a second quantity of bits associated with the second information. In some examples, the management frame is a beacon frame.

In some examples, the update to the one or more parameters is in accordance with one or more types of a wireless communication network including the wireless communication device or in accordance with one or more features supported by the wireless communication device.

FIG. 6 shows a flowchart illustrating an example process 600 performable by or at a wireless communication device that supports early indication of updates to wireless parameters. The operations of the process 600 may be implemented by a wireless communication device or its components as described herein. For example, the process 600 may be performed by a wireless communication device, such as the wireless communication device 400 described with reference to FIG. 4, operating as or within a wireless STA. In some examples, the process 600 may be performed by a wireless STA, such as one of the STAs 104 described with reference to FIG. 1.

In some examples, in 605, the wireless communication device may establish a communication link with an AP of one or more APs. In some implementations, aspects of the operations of 605 may be performed by a Communication Configuration Component 425 as described with reference to FIG. 4.

In some examples, in 610, the wireless communication device may receive, from the AP, a management frame including: one or more first fields and one or more second fields of a set of multiple fields in an early portion of the management frame, the one or more first fields being earlier in the management frame than the one or more second fields, the one or more first fields including first information related to whether there is an update to one or more parameters associated with one or more BSSIDs associated with the one or more APs, the one or more second fields including second information indicating update information associated with the update to the one or more parameters associated with the one or more BSSIDs associated with the one or more APs, the second information being in accordance with the first information indicating the update. In some implementations, aspects of the operations of 610 may be performed by a Critical Update Component 430 as described with reference to FIG. 4.

In some examples, in 615, the wireless communication device may communicate, with the AP, in accordance with the first information and the second information. In some implementations, aspects of the operations of 615 may be performed by a Communication Configuration Component 425 as described with reference to FIG. 4.

FIG. 7 shows a flowchart illustrating an example process 700 performable by or at a wireless communication device that supports early indication of updates to wireless parameters. The operations of the process 700 may be implemented by a wireless communication device or its components as described herein. For example, the process 700 may be performed by a wireless communication device, such as the wireless communication device 400 described with reference to FIG. 4, operating as or within a wireless STA. In some examples, the process 700 may be performed by a wireless STA, such as one of the STAs 104 described with reference to FIG. 1.

In some examples, in 705, the wireless communication device may establish a communication link with an AP of one or more APs. In some implementations, aspects of the operations of 705 may be performed by a Communication Configuration Component 425 as described with reference to FIG. 4.

In some examples, in 710, the wireless communication device may receive, from the AP, a management frame including: one or more first fields and one or more second fields of a set of multiple fields in an early portion of the management frame, the one or more first fields being earlier in the management frame than the one or more second fields, the one or more first fields including first information related to whether there is an update to one or more parameters associated with one or more BSSIDs associated with the one or more APs, the one or more second fields including second information indicating update information associated with the update to the one or more parameters associated with the one or more BSSIDs associated with the one or more APs, the second information being in accordance with the first information indicating the update. In some implementations, aspects of the operations of 710 may be performed by a Critical Update Component 430 as described with reference to FIG. 4.

In some examples, in 715, the wireless communication device may receive, via one or more third fields in a later portion of the management frame subsequent to the early portion of the management frame, communication configuration information for the one or more parameters based on determining an applicability of the update to the wireless communication device according to the update information. In some implementations, aspects of the operations of 715 may be performed by an Communication Configuration Information Component 435 as described with reference to FIG. 4.

In some examples, in 720, the wireless communication device may communicate, with the AP, in accordance with the first information and the second information. In some implementations, aspects of the operations of 720 may be performed by a Communication Configuration Component 425 as described with reference to FIG. 4.

FIG. 8 shows a flowchart illustrating an example process 800 performable by or at an AP that supports early indication of updates to wireless parameters. The operations of the process 800 may be implemented by an AP or its components as described herein. For example, the process 800 may be performed by a wireless communication device, such as the wireless communication device 500 described with reference to FIG. 5, operating as or within a wireless AP. In some examples, the process 800 may be performed by a wireless AP, such as one of the APs 102 described with reference to FIG. 1.

In some examples, in 805, the AP may establish a communication link with a wireless communication device. In some implementations, aspects of the operations of 805 may be performed by a Communication Configuration Component 525 as described with reference to FIG. 5.

In some examples, in 810, the AP may transmit a management frame including: one or more first fields and one or more second fields of a set of multiple fields in an early portion of the management frame, the one or more first fields being earlier in the management frame than the one or more second fields, the one or more first fields including first information related to whether there is an update to one or more parameters associated with one or more BSSIDs associated with one or more APs, the one or more second fields including second information indicating update information associated with the update to the one or more parameters associated with the one or more BSSIDs associated with the one or more APs, the second information being in accordance with the first information indicating the update. In some implementations, aspects of the operations of 810 may be performed by a Critical Update Component 530 as described with reference to FIG. 5.

In some examples, in 815, the AP may communicate, with the wireless communication device, in accordance with the first information and the second information. In some implementations, aspects of the operations of 815 may be performed by a Communication Configuration Component 525 as described with reference to FIG. 5.

FIG. 9 shows a flowchart illustrating an example process 900 performable by or at an AP that supports early indication of updates to wireless parameters. The operations of the process 900 may be implemented by an AP or its components as described herein. For example, the process 900 may be performed by a wireless communication device, such as the wireless communication device 500 described with reference to FIG. 5, operating as or within a wireless AP. In some examples, the process 900 may be performed by a wireless AP, such as one of the APs 102 described with reference to FIG. 1.

In some examples, in 905, the AP may establish a communication link with a wireless communication device. In some implementations, aspects of the operations of 905 may be performed by a Communication Configuration Component 525 as described with reference to FIG. 5.

In some examples, in 910, the AP may transmit a management frame including: one or more first fields and one or more second fields of a set of multiple fields in an early portion of the management frame, the one or more first fields being earlier in the management frame than the one or more second fields, the one or more first fields including first information related to whether there is an update to one or more parameters associated with one or more BSSIDs associated with one or more APs, the one or more second fields including second information indicating update information associated with the update to the one or more parameters associated with the one or more BSSIDs associated with the one or more APs, the second information being in accordance with the first information indicating the update. In some implementations, aspects of the operations of 910 may be performed by a Critical Update Component 530 as described with reference to FIG. 5.

In some examples, in 915, the AP may update a communication configuration of the AP in accordance with the update to the one or more parameters associated with the one or more BSSIDs. Communicating with the wireless communication device may be in accordance with updating the communication configuration. In some implementations, aspects of the operations of 915 may be performed by a Communication Configuration Update Component 535 as described with reference to FIG. 5.

In some examples, in 920, the AP may communicate, with the wireless communication device, in accordance with the first information and the second information. In some implementations, aspects of the operations of 920 may be performed by a Communication Configuration Component 525 as described with reference to FIG. 5.

Implementation examples are described in the following numbered clauses:

Clause 1: A method for wireless communication at a wireless communication device, including: establishing a communication link with an AP of one or more APs; receiving, from the AP, a management frame including: one or more first fields and one or more second fields of a plurality of fields in an early portion of the management frame, the one or more first fields being earlier in the management frame than the one or more second fields, the one or more first fields including first information related to whether there is an update to one or more parameters associated with one or more BSSIDs associated with the one or more APs, the one or more second fields including second information indicating update information associated with the update to the one or more parameters associated with the one or more BSSIDs associated with the one or more APs, the second information being in accordance with the first information indicating the update; and communicating, with the AP, in accordance with the first information and the second information.

Clause 2: The method of Clause 1, further including: receiving, via one or more third fields in a later portion of the management frame subsequent to the early portion of the management frame, communication configuration information for the one or more parameters based on determining an applicability of the update to the wireless communication device according to the update information.

Clause 3: The method of Clause 2, further including: updating a communication configuration of the wireless communication device in accordance with the communication configuration information for the one or more parameters, where communicating with the AP is in accordance with updating the communication configuration.

Clause 4: The method of any of Clauses 2-3, further including: receiving, from the AP, one or more indications that the communication configuration information is included in the management frame, where receiving the communication configuration information via the one or more third fields in the later portion of the management frame is in accordance with the one or more indications that the communication configuration information is included in the management frame.

Clause 5: The method of Clause 1, further including: receiving, from the AP, a second management frame including communication configuration information for the one or more parameters, where receiving the second management frame is in accordance with the first information and the second information indicating the update to the one or more parameters.

Clause 6: The method of any of Clauses 1-5, further including: receiving, from the AP and via the second information, a bitmap indicating a set of types of one or more wireless communication networks that is applicable to the update to the one or more parameters associated with the one or more BSSIDs, where the update to the one or more parameters associated with the one or more BSSIDs is in accordance with one or more types supported by the wireless communication device including at least one type of the set of types.

Clause 7: The method of any of Clauses 1-6, further including: receiving, from the AP and via the second information, a bitmap indicating one or more communication links to which the update to the one or more parameters applies.

Clause 8: The method of any of Clauses 1-7, further including: receiving, from the AP and via the second information, a bitmap indicating a subset of the one or more BSSIDs to which the update to the one or more parameters applies.

Clause 9: The method of any of Clauses 1-8, further including: receiving, from the AP and via the second information, a first indication of a first quantity of updates to a first plurality of parameters indicating a first communication configuration of the wireless communication device, where the first plurality of parameters include the one or more parameters.

Clause 10: The method of Clause 9, further including: receiving, from the AP and via the second information, a second indication of a second quantity of updates to a second plurality of parameters indicating a second communication configuration of the wireless communication device, where the first communication configuration is in accordance with the communication link and the second communication configuration is in accordance with a second communication link.

Clause 11: The method of any of Clauses 1-10, further including: receiving, from the AP and via the second information, an indication of a first counter indicating a first quantity of management frames until implementation of the update to the one or more parameters associated with the one or more BSSIDs, where the first counter is in accordance with a first update timeline for the update to the one or more parameters.

Clause 12: The method of Clause 11, further including: receiving, prior to a reception of the management frame, a second management frame including third information indicating a second counter indicating a second quantity of management frames until implementation of the update to the one or more parameters, where the second counter is in accordance with a second update timeline for the update to the one or more parameters different than the first update timeline, and where the second information indicates an asynchronous update to at least the one or more parameters associated with the one or more BSSIDs in accordance with the second quantity of the second counter being less than the first quantity of the first counter.

Clause 13: The method of any of Clauses 5-12, further including: maintaining a communication configuration of the wireless communication device in accordance with the first information and the second information indicating that no parameters of the one or more parameters associated with the one or more BSSIDs are scheduled for an update within a duration.

Clause 14: The method of any of Clauses 1-13, where the one or more first fields include a capability information field, the one or more second fields include at least a portion of a timing indication map, a first quantity of bits associated with the first information is greater than a second quantity of bits associated with the second information, and the management frame is a beacon frame.

Clause 15: The method of any of Clauses 1-14, where the update to the one or more parameters is in accordance with one or more types of a wireless communication network including the wireless communication device or in accordance with one or more features supported by the wireless communication device.

Clause 16: A method for wireless communication at an AP, including: establishing a communication link with a wireless communication device; transmitting a management frame including: one or more first fields and one or more second fields of a plurality of fields in an early portion of the management frame, the one or more first fields being earlier in the management frame than the one or more second fields, the one or more first fields including first information related to whether there is an update to one or more parameters associated with one or more BSSIDs associated with one or more APs, the one or more second fields including second information indicating update information associated with the update to the one or more parameters associated with the one or more BSSIDs associated with the one or more APs, the second information being in accordance with the first information indicating the update; and communicating, with the wireless communication device, in accordance with the first information and the second information.

Clause 17: The method of Clause 16, further including: updating a communication configuration of the AP in accordance with the update to the one or more parameters associated with the one or more BSSIDs, where communicating with the wireless communication device is in accordance with updating the communication configuration.

Clause 18: The method of any of Clauses 16-17, further including: transmitting, via one or more third fields in a later portion of the management frame subsequent to the early portion of the management frame, communication configuration information for the one or more parameters.

Clause 19: The method of Clause 18, further including: transmitting one or more indications that the communication configuration information is included in the management frame, where transmitting the communication configuration information via the one or more third fields in the later portion of the management frame is in accordance with the one or more indications that the communication configuration information is included in the management frame.

Clause 20: The method of any of Clauses 16-17, further including: transmitting a second management frame including communication configuration information for the one or more parameters, where transmitting the second management frame is in accordance with the first information and the second information indicating the update to the one or more parameters.

Clause 21: The method of any of Clauses 16-20, further including: transmitting, via the second information, a bitmap indicating a set of types of one or more wireless communication networks that is applicable to the update to the one or more parameters associated with the one or more BSSIDs, where the update to the one or more parameters associated with the one or more BSSIDs is in accordance with one or more types supported by the wireless communication device including at least one type of the set of types.

Clause 22: The method of any of Clauses 16-21, further including: transmitting, via the second information, a bitmap indicating one or more communication links to which the update to the one or more parameters applies.

Clause 23: The method of any of Clauses 16-22, further including: transmitting, via the second information, a bitmap indicating a subset of the one or more BSSIDs to which the update to the one or more parameters applies.

Clause 24: The method of any of Clauses 16-23, further including: transmitting, via the second information, a first indication of a first quantity of updates to a first plurality of parameters indicating a first communication configuration of the wireless communication device, where the first plurality of parameters include the one or more parameters.

Clause 25: The method of Clause 24, further including: transmitting, via the second information, a second indication of a second quantity of updates to a second plurality of parameters indicating a second communication configuration of the wireless communication device, where the first communication configuration is in accordance with the communication link and the second communication configuration is in accordance with a second communication link.

Clause 26: The method of any of Clauses 16-25, further including: transmitting, via the second information, an indication of a first counter indicating a first quantity of management frames until implementation of the update to the one or more parameters associated with the one or more BSSIDs, where the first counter is in accordance with a first update timeline for the update to the one or more parameters.

Clause 27: The method of Clause 26, further including: transmitting, prior to a reception of the management frame, a second management frame including third information indicating a second counter indicating a second quantity of management frames until implementation of the update to the one or more parameters, where the second counter is in accordance with a second update timeline for the update to the one or more parameters different than the first update timeline, and where the second information indicates an asynchronous update to at least the one or more parameters associated with the one or more BSSIDs in accordance with the second quantity of the second counter being less than the first quantity of the first counter.

Clause 28: The method of any of Clauses 16-27, where the one or more first fields include a capability information field, the one or more second fields include at least a portion of a timing indication map, a first quantity of bits associated with the first information is greater than a second quantity of bits associated with the second information, and the management frame is a beacon frame.

Clause 29: The method of any of Clauses 16-28, where the update to the one or more parameters is in accordance with one or more types of a wireless communication network including the wireless communication device or in accordance with one or more features supported by the wireless communication device.

Clause 30: A wireless communication device for wireless communication, including a processing system that includes processor circuitry and memory circuitry that stores code, the processing system configured to cause the wireless communication device to perform a method of any of Clauses 1-15.

Clause 31: A wireless communication device for wireless communication, including at least one means for performing a method of any of Clauses 1-15.

Clause 32: A non-transitory computer-readable medium storing code for wireless communication, the code including instructions executable by one or more processors to perform a method of any of Clauses 1-15.

Clause 33: An AP for wireless communication, including a processing system that includes processor circuitry and memory circuitry that stores code, the processing system configured to cause the AP to perform a method of any of Clauses 16-29.

Clause 34: An AP for wireless communication, including at least one means for performing a method of any of Clauses 16-29.

Clause 35: A non-transitory computer-readable medium storing code for wireless communication, the code including instructions executable by one or more processors to perform a method of any of Clauses 16-29.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A wireless communication device, comprising:
a processing system that includes processor circuitry and memory circuitry that stores code, the processing system configured when executing the code to cause the wireless communication device to:
establish a communication link with an access point (AP) of one or more APs;
receive, from the AP, a management frame comprising:
one or more first fields and one or more second fields of a plurality of fields in an early portion of the management frame, the one or more first fields being earlier in the management frame than the one or more second fields, the one or more first fields comprising first information related to whether there is an update to one or more parameters associated with one or more basic service set identifiers associated with the one or more APs, the one or more second fields comprising second information indicating update information associated with the update to the one or more parameters associated with the one or more basic service set identifiers associated with the one or more APs, the second information being in accordance with the first information indicating the update; and
communicate, with the AP, in accordance with the first information and the second information.

2. The wireless communication device of claim 1, wherein the processing system is further configured when executing the code to cause the wireless communication device to:
receive, via one or more third fields in a later portion of the management frame subsequent to the early portion of the management frame, communication configuration information for the one or more parameters based on determining an applicability of the update to the wireless communication device according to the update information.

3. The wireless communication device of claim 2, wherein the processing system is further configured when executing the code to cause the wireless communication device to:
update a communication configuration of the wireless communication device in accordance with the communication configuration information for the one or more parameters, wherein communicating with the AP is in accordance with updating the communication configuration.

4. The wireless communication device of claim 2, wherein the processing system is further configured when executing the code to cause the wireless communication device to:
receive, from the AP, one or more indications that the communication configuration information is included in the management frame, wherein receiving the communication configuration information via the one or more third fields in the later portion of the management frame is in accordance with the one or more indications that the communication configuration information is included in the management frame.

5. The wireless communication device of claim 1, wherein the processing system is further configured when executing the code to cause the wireless communication device to:
receive, from the AP, a second management frame comprising communication configuration information for the one or more parameters, wherein receiving the second management frame is in accordance with the first information and the second information indicating the update to the one or more parameters.

6. The wireless communication device of claim 1, wherein the processing system is further configured when executing the code to cause the wireless communication device to:
receive, from the AP and via the second information, a bitmap indicating a set of types of one or more wireless communication networks that is applicable to the update to the one or more parameters associated with the one or more basic service set identifiers, wherein the update to the one or more parameters associated with the one or more basic service set identifiers is in accordance with one or more types supported by the wireless communication device comprising at least one type of the set of types.

7. The wireless communication device of claim 1, wherein the processing system is further configured when executing the code to cause the wireless communication device to:
receive, from the AP and via the second information, a bitmap indicating one or more communication links to which the update to the one or more parameters applies.

8. The wireless communication device of claim 1, wherein the processing system is further configured when executing the code to cause the wireless communication device to:
receive, from the AP and via the second information, a bitmap indicating a subset of the one or more basic service set identifiers to which the update to the one or more parameters applies.

9. The wireless communication device of claim 1, wherein the processing system is further configured when executing the code to cause the wireless communication device to:
receive, from the AP and via the second information, a first indication of a first quantity of updates to a first plurality of parameters indicating a first communication configuration of the wireless communication device, wherein the first plurality of parameters comprise the one or more parameters.

10. The wireless communication device of claim 9, wherein the processing system is further configured when executing the code to cause the wireless communication device to:
receive, from the AP and via the second information, a second indication of a second quantity of updates to a second plurality of parameters indicating a second communication configuration of the wireless communication device, wherein the first communication configuration is in accordance with the communication link and the second communication configuration is in accordance with a second communication link.

11. The wireless communication device of claim 1, wherein the processing system is further configured when executing the code to cause the wireless communication device to:
receive, from the AP and via the second information, an indication of a first counter indicating a first quantity of management frames until implementation of the update to the one or more parameters associated with the one or more basic service set identifiers, wherein the first counter is in accordance with a first update timeline for the update to the one or more parameters.

12. The wireless communication device of claim 11, wherein the processing system is further configured when executing the code to cause the wireless communication device to:
receive, prior to a reception of the management frame, a second management frame comprising third information indicating a second counter indicating a second quantity of management frames until implementation of the update to the one or more parameters, wherein the second counter is in accordance with a second update timeline for the update to the one or more parameters different than the first update timeline, and wherein the second information indicates an asynchronous update to at least the one or more parameters associated with the one or more basic service set identifiers in accordance with the second quantity of the second counter being less than the first quantity of the first counter.

13. The wireless communication device of claim 1, wherein the processing system is further configured when executing the code to cause the wireless communication device to:
maintain a communication configuration of the wireless communication device in accordance with the first information and the second information indicating that no parameters of the one or more parameters associated with the one or more basic service set identifiers are scheduled for an update within a duration.

14. The wireless communication device of claim 1, wherein the one or more first fields comprise a capability information field, wherein the one or more second fields comprise at least a portion of a timing indication map, wherein a first quantity of bits associated with the first information is greater than a second quantity of bits associated with the second information, and wherein the management frame is a beacon frame.

15. The wireless communication device of claim 1, wherein the update to the one or more parameters is in accordance with one or more types of a wireless communication network comprising the wireless communication device or in accordance with one or more features supported by the wireless communication device.

16. An access point (AP), comprising:
a processing system that includes processor circuitry and memory circuitry that stores code, the processing system configured when executing the code to cause the AP to:
establish a communication link with a wireless communication device;
transmit a management frame comprising:
one or more first fields and one or more second fields of a plurality of fields in an early portion of the management frame, the one or more first fields being earlier in the management frame than the one or more second fields, the one or more first fields comprising first information related to whether there is an update to one or more parameters associated with one or more basic service set identifiers associated with one or more APs, the one or more second fields comprising second information indicating update information associated with the update to the one or more parameters associated with the one or more basic service set identifiers associated with the one or more APs, the second information being in accordance with the first information indicating the update; and
communicate, with the wireless communication device, in accordance with the first information and the second information.

17. The AP of claim 16, wherein the processing system is further configured to cause the AP to:
update a communication configuration of the AP in accordance with the update to the one or more parameters associated with the one or more basic service set identifiers, wherein communicating with the wireless communication device is in accordance with updating the communication configuration.

18. The AP of claim 16, wherein the processing system is further configured when executing the code to cause the AP to:
transmit, via one or more third fields in a later portion of the management frame subsequent to the early portion of the management frame, communication configuration information for the one or more parameters.

19. The AP of claim 18, wherein the processing system is further configured when executing the code to cause the AP to:
transmit one or more indications that the communication configuration information is included in the management frame, wherein transmitting the communication configuration information via the one or more third fields in the later portion of the management frame is in accordance with the one or more indications that the communication configuration information is included in the management frame.

20. The AP of claim 16, wherein the processing system is further configured when executing the code to cause the AP to:
transmit a second management frame comprising communication configuration information for the one or more parameters, wherein transmitting the second management frame is in accordance with the first information and the second information indicating the update to the one or more parameters.

21. The AP of claim 16, wherein the processing system is further configured when executing the code to cause the AP to:
transmit, via the second information, a bitmap indicating a set of types of one or more wireless communication networks that is applicable to the update to the one or more parameters associated with the one or more basic service set identifiers, wherein the update to the one or more parameters associated with the one or more basic service set identifiers is in accordance with one or more types supported by the wireless communication device comprising at least one type of the set of types.

22. The AP of claim 16, wherein the processing system is further configured when executing the code to cause the AP to:
transmit, via the second information, a bitmap indicating one or more communication links to which the update to the one or more parameters applies.

23. The AP of claim 16, wherein the processing system is further configured to cause the AP to:
transmit, via the second information, a bitmap indicating a subset of the one or more basic service set identifiers to which the update to the one or more parameters applies.

24. The AP of claim 16, wherein the processing system is further configured when executing the code to cause the AP to:
transmit, via the second information, a first indication of a first quantity of updates to a first plurality of parameters indicating a first communication configuration of the wireless communication device, wherein the first plurality of parameters comprise the one or more parameters.

25. The AP of claim 24, wherein the processing system is further configured when executing the code to cause the AP to:
transmit, via the second information, a second indication of a second quantity of updates to a second plurality of parameters indicating a second communication configuration of the wireless communication device, wherein the first communication configuration is in accordance with the communication link and the second communication configuration is in accordance with a second communication link.

26. The AP of claim 16, wherein the processing system is further configured when executing the code to cause the AP to:
transmit, via the second information, an indication of a first counter indicating a first quantity of management frames until implementation of the update to the one or more parameters associated with the one or more basic service set identifiers, wherein the first counter is in accordance with a first update timeline for the update to the one or more parameters.

27. The AP of claim 16, wherein the one or more first fields comprise a capability information field, wherein the one or more second fields comprise at least a portion of a timing indication map, wherein a first quantity of bits associated with the first information is greater than a second quantity of bits associated with the second information, and wherein the management frame is a beacon frame.

28. The AP of claim 16, wherein the update to the one or more parameters is in accordance with one or more types of a wireless communication network comprising the wireless communication device or in accordance with one or more features supported by the wireless communication device.

29. A method for wireless communication at a wireless communication device, comprising:
establishing a communication link with an access point (AP) of one or more APs;
receiving, from the AP, a management frame comprising:
one or more first fields and one or more second fields of a plurality of fields in an early portion of the management frame, the one or more first fields being earlier in the management frame than the one or more second fields, the one or more first fields comprising first information related to whether there is an update to one or more parameters associated with one or more basic service set identifiers associated with the one or more APs, the one or more second fields comprising second information indicating update information associated with the update to the one or more parameters associated with the one or more basic service set identifiers associated with the one or more APs, the second information being in accordance with the first information indicating the update; and
communicating, with the AP, in accordance with the first information and the second information.

30. A method for wireless communication at an access point (AP), comprising:
establishing a communication link with a wireless communication device;
transmitting a management frame comprising:
one or more first fields and one or more second fields of a plurality of fields in an early portion of the management frame, the one or more first fields being earlier in the management frame than the one or more second fields, the one or more first fields comprising first information related to whether there is an update to one or more parameters associated with one or more basic service set identifiers associated with one or more APs, the one or more second fields comprising second information indicating update information associated with the update to the one or more parameters associated with the one or more basic service set identifiers associated with the one or more APs, the second information being in accordance with the first information indicating the update; and
communicating, with the wireless communication device, in accordance with the first information and the second information.
